(19) United States
(12) Patent Application Publication
(10) Pub. No.: US 2006/0256353 A1
(43) Pub. Date: Nov. 16, 2006

(54) Image reading apparatus capable of reading high-quality image and image forming apparatus capable of forming high-quality image

(75) Inventors: Takashi Noda, Okazaki-Shi (JP); Masahiro Nonoyama, Toyokawa-Shi (JP); Toshikazu Higashi, Aichi-ken (JP); Norihiko Nakano, Toyokawa-Shi (JP)

Correspondence Address: MORRISON & FOERSTER LLP, 1650 TYSONS BOULEVARD, SUITE 300, MCLEAN, VA, 22102, US

(73) Assignee: Konica Minolta Business Technologies, Inc., Tokyo (JP)

(21) Appl. No.: 11/210,739

(22) Filed: Aug. 25, 2005

(30) Foreign Application Priority Data
May 10, 2005 (JP) 2005-137324

(51) Int. Cl. G06F 3/12

(52) U.S. Cl. 358/1.1

(57) ABSTRACT

If a moving speed of a transparent member is determined as not larger than a prescribed moving speed, a used transmission portion out of a transmission portion of the transparent member is changed to a prescribed transmission portion that has been set in advance. If the used transmission portion is changed to the prescribed transmission portion, the moving speed of the transparent member is set to a moving speed based on the prescribed transmission portion.

This application is based on Japanese Patent Application No. 2005-137324 filed with the Japan Patent Office on May 10, 2005, the entire content of which is hereby incorporated by reference.

### BACKGROUND OF THE INVENTION

1. Field of the Invention

The present invention relates to an image reading apparatus and an image forming apparatus, and more particularly to an image reading apparatus and an image forming apparatus reading a moving document.

2. Description of the Related Art

An image reading apparatus or an image forming apparatus of a type optically reading a document as an image performs image reading processing by irradiating the document with light and receiving the light reflected therefrom with an image sensor such as a CCD sensor. The image reading apparatus is generally categorized into a stationary-document type image reading apparatus and a moving-document type image reading apparatus. The stationary-document type image reading apparatus performs optical scanning by moving an optical portion for image reading processing with respect to a stationary document. The moving-document type image reading apparatus performs optical scanning by arranging an optical portion at a prescribed position and moving a document with respect to the optical portion.

The moving-document type image reading apparatus includes a document glass, so that a document moves along the same. A light source that emits light and an image sensor are arranged under the document glass. The light from the light source impinges on the document through the document glass, and the light reflected therefrom is input to the image sensor through the document glass.

As such, if a foreign matter such as dirt, dust or stain is adhered to the document glass, a line or a strip (hereinafter, also referred to as stripe noise) may appear on the image read by the image sensor due to the foreign matter, resulting in lower quality of the image.

Japanese Laid-Open Patent Publication No. 2000-324312 discloses a technique to suppress stripe noise by moving a document glass simultaneously with movement of a document in a moving-document type image reading apparatus.

According to the technique disclosed in Japanese Laid-Open Patent Publication No. 2000-324312, however, if an area where a foreign matter is present on the document glass is not smaller than a prescribed area, it is difficult to achieve satisfactory quality of the read document.

In addition, a user notices occurrence of such a problem only after image reading processing is completed and the read image data is printed on paper or the like when the area where a foreign matter is present on the document glass is not smaller than the prescribed area. Therefore, a user who desires high-quality image reading processing should clean the document glass after the image reading processing is completed, and perform again the image reading processing. In other words, user's unnecessary trouble is caused.

### SUMMARY OF THE INVENTION

An object of the present invention is to provide an image reading apparatus capable of reading a high-quality image and minimizing user's unnecessary trouble.

Another object of the present invention is to provide an image forming apparatus capable of forming a high-quality image and minimizing user's unnecessary trouble.

According to one aspect of the present invention, an image forming apparatus includes: a document transportation portion for transporting a document in a prescribed direction, a light exposure portion exposing the document to light; a transparent member having a transparent portion allowing passage of the light reflected from the document; a drive portion for moving the transparent member in a direction opposite to the prescribed direction when the document is read; a document reading portion for reading the light reflected from the document; an image forming portion forming an image on a prescribed target based on information read by the document reading portion; a first portion setting portion setting a first transmission portion included in the transparent portion in the transparent member as a transmission area used for allowing passage of the reflected light when the document is read; a speed setting portion for setting a moving speed of the transparent member based on the first transmission portion; a moving speed determination portion for determining whether the set moving speed of the transparent member is equal to or smaller than a prescribed moving speed; and a change portion for changing the transmission area from the first transmission portion to a second transmission portion that has been set in advance when the moving speed determination portion determines that the moving speed of the transparent member is equal to or smaller than the prescribed moving speed. The speed setting portion sets the moving speed of the transparent member to a moving speed based on the second transmission portion when the change portion changes the transmission area from the first transmission portion to the second transmission portion.

According to another aspect of the present invention, an image forming apparatus includes: a document transportation portion for transporting a document in a prescribed direction; a light exposure portion exposing the document to light; a transparent member having a transparent portion allowing passage of the light reflected from the document; a drive portion for moving the transparent member in a direction opposite to the prescribed direction when the document is read; a document reading portion for reading the light reflected from the document; an image forming portion forming an image on a prescribed target based on information read by the document reading portion; a first portion setting portion setting a first transmission portion included in the transparent portion in the transparent member as a transmission area used for allowing passage of the reflected light when the document is read; a speed setting portion for setting a moving speed of the transparent member based on the first transmission portion; a moving speed determination portion for determining whether the set moving speed of the transparent member is equal to or smaller than a prescribed moving speed; and a control portion stopping execution of document reading using the first transmission portion when the moving speed determination portion determines that the moving speed of the transparent member is equal to or smaller than the prescribed moving speed.

According to yet another aspect of the present invention, an image reading apparatus includes: a document transportation portion for transporting a document in a prescribed direction; a light exposure portion exposing the document to light; a transparent member having a transparent portion allowing passage of the light reflected from the document; a drive portion for moving the transparent member in a direction opposite to the prescribed direction when the document is read; a document reading portion for reading the light reflected from the document; a first portion setting portion setting a first transmission portion included in the transparent portion in the transparent member as a transmission area used for allowing passage of the reflected light when the document is read; a speed setting portion for setting a moving speed of the transparent member based on the first transmission portion; a moving speed determination portion for determining whether the set moving speed of the transparent member is equal to or smaller than a prescribed moving speed; and a change portion for changing the transmission area from the first transmission portion to a second transmission portion that has been set in advance when the moving speed determination portion determines that the moving speed of the transparent member is equal to or smaller than the prescribed moving speed. The speed setting portion sets the moving speed of the transparent member to a moving speed based on the second transmission portion when the change portion changes the transmission area from the transmission portion to the second transmission portion.

According to yet another aspect of the present invention, a method of reading an image includes the steps of: transporting a document in a prescribed direction; exposing the document to light; moving a transparent member having a transparent portion allowing passage of the light reflected from the document in a direction opposite to the prescribed direction when the document is read; reading the light reflected from the document; setting a first transmission portion included in the transparent portion in the transparent member as a transmission area used for allowing passage of the reflected light when the document is read; setting a moving speed of the transparent member based on the first transmission portion; determining whether the set moving speed of the transparent member is equal to or smaller than a prescribed moving speed; changing the transmission area from the first transmission portion to a second transmission portion that has been set in advance when it is determined at the determining step that the moving speed of the transparent member is equal to or smaller than the prescribed moving speed; and setting the moving speed of the transparent member to a moving speed based on the second transmission portion when the change portion changes the transmission portion to the second transmission portion.

Therefore, according to the present invention, lowering in the quality of reading by the document reading portion caused when the moving speed of the transparent member is not larger than the prescribed moving speed can be prevented, and the document reading portion can effectively read a high-quality image.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing an internal configuration of an image forming apparatus.

FIG. 2 is a block diagram showing an internal control configuration of the image forming apparatus.

FIG. 3 is a block diagram showing an internal configuration of an image processing portion.

FIGS. 4A to 4D illustrate a method of setting a moving speed of a contact glass.

FIG. 5 shows in a graph speed variation with respect to the glass moving speed.

FIG. 6 shows appearance of an operation panel unit.

FIG. 7 is a flowchart of initial setting processing.

FIGS. 8A and 8B show an image displayed on a display portion.

FIGS. 9A and 9B show an image displayed on the display portion.

FIG. 10 is a flowchart of processing for glass movement effective length switch setting.

FIGS. 11A and 11B show an image displayed on the display portion.

FIG. 12 is a flowchart of processing for setting an operation when a moving speed attains a limit.

FIG. 13 is a flowchart of processing for setting a glass moving speed.

FIGS. 14A and 14B show an image displayed on the display portion.

FIG. 15 is a flowchart of initial setting processing.

FIG. 16 is a flowchart of processing for glass moving distance switch setting.

FIG. 17 is a flowchart of processing for setting warning timing.

FIG. 18 shows an exemplary image for setting warning timing displayed on the display portion.

FIG. 19 is a flowchart of image forming processing.

FIG. 20 is a flowchart of processing for setting a glass moving condition.

FIG. 21 is a flowchart of processing for automatically calculating the glass movement effective length.

FIGS. 22A to 22D show a state of a large foreign matter detected on the contact glass through processing for detecting a large foreign matter.

FIG. 23 is a flowchart of warning processing.

FIG. 24 shows an exemplary image for warning at the time when JOB is interrupted.

FIGS. 25A and 25B show an image displayed on the display portion.

FIG. 26 shows an exemplary image for warning at the time when a job is finished.

### DESCRIPTION OF THE PREFERRED EMBODIMENTS

An embodiment of the present invention will be described hereinafter with reference to the drawings. The same elements have the same reference characters allotted, and their label and function are also identical. Therefore, detailed description thereof will not be repeated.

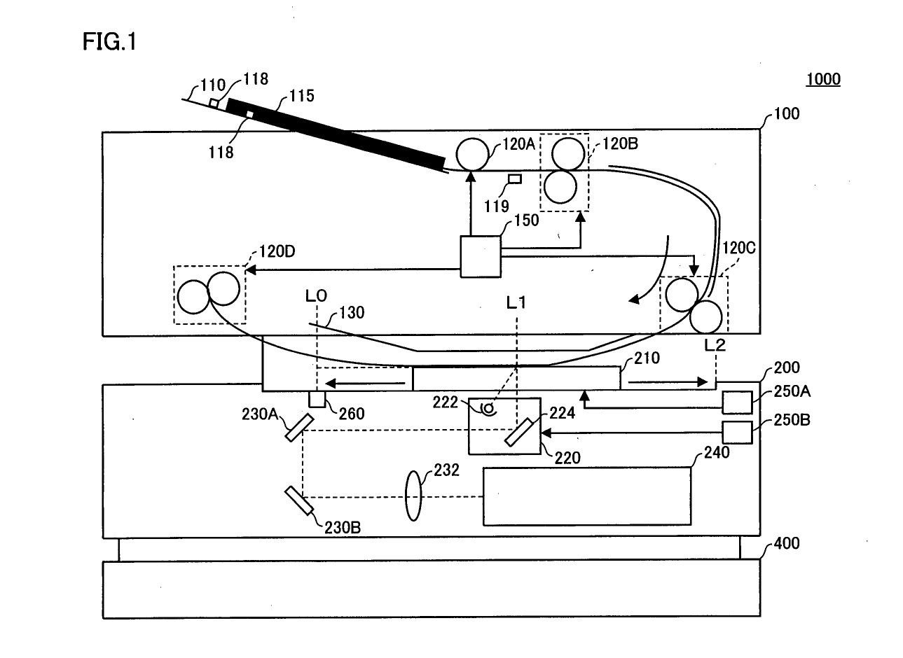

Referring to FIG. 1, an image forming apparatus 1000 includes an automatic document feeder (hereinafter, also referred to as ADF) 100, an image reading unit 200, and an image forming portion 400.

ADF 100 includes a paper feed tray 110, a paper feed roller 120A, a separation roller 120B, a pre-reading roller 120C, a post-reading roller 120D, a drive pulse motor 150, and a white background screen 130.

A document group 115 is set on paper feed tray 110. Document group 115 includes a plurality of documents. A document size detection sensor 118 for detecting a size of a document in a vertical scanning direction (hereinafter, also referred to as a document FD length) is provided on a surface of paper feed tray 110. In addition, a document passage sensor 119 is provided between paper feed roller 120A and separation roller 120B. Document passage sensor 119 determines whether or not a document is passing the sensor.

Drive pulse motor 150 controls an operation of paper feed roller 120A, separation roller 120B, pre-reading roller 120C, and post-reading roller 120D independently of each other. Each of paper feed roller 120A, separation roller 120B and pre-reading roller 120C performs a rotation operation under the control of drive pulse motor 150, so as to take in documents set on paper feed tray 110 and transport the same as far as a document reading position L1 one by one.

Post-reading roller 120D performs processing for outputting the document that has passed document reading position L1 to a not-shown output stack tray or processing for transporting the same to a path for reading a backside of the document, under the control of drive pulse motor 150.

Image reading unit 200 includes a contact glass 210, a reading slider unit 220, mirrors 230A, 230B, a lens 232, an image processing portion 240, a drive pulse motor 250A, and a drive pulse motor 250B.

Reading slider unit 220 has a light exposure portion 222 and a mirror 224. Drive pulse motor 250B controls reading slider unit 220 such that it moves in a left-right direction.

Drive pulse motor 250A controls contact glass 210 such that it moves in the left-right direction.

Contact glass 210 moves in the left-right direction within a range from a reference position L0 to a position L2, under the control of drive pulse motor 250A during transportation of the document from ADF 100.

Light exposure portion 222 attains light exposure function. Mirrors 230A, 230B are arranged so as to transmit the light received by mirror 224 to image processing portion 240 through lens 232. Image processing portion 240 attains a function to convert the input light to image data.

A plurality of documents included in document group 115 set on paper feed tray 110 are taken in ADF 100 one by one by paper feed roller 120A, and transported as far as document reading position L1 by the rotation operation of separation roller 120B and pre-reading roller 120C.

Light exposure portion 222 exposes the document to light during a period from a time point immediately after the document is transported to document reading position L1 to a time point when the document passes document reading position L1. The light reflected from the document exposed to light transmits to image processing portion 240 by mirrors 224, 230A, 230B and lens 232. Image processing portion 240 reads the document as an image by converting the transmitted light to image data. In the following, processing performed by image processing portion 240 for reading the document as an image is also referred to as the image reading processing.

Image reading unit 200 further includes a reference position detection sensor 260.

Reference position detection sensor 260 detects whether or not contact glass 210 is at reference position L0.

During a period in which the image reading processing is not performed, contact glass 210 rests at a position where the left end thereof is located at reference position L0. In the image reading processing, movement of contact glass 210 is controlled by drive pulse motor 250A such that it moves in a direction opposite to a direction of transportation of the document from ADF 100. Specifically, contact glass 210 is controlled to start moving toward position L2 in synchronization with arrival of the end portion of the document transported from ADF 100 at document reading position L1. In addition, movement of contact glass 210 is controlled by drive pulse motor 250A such that the right end thereof is positioned at position L2 when one document finishes passing document reading position L1.

When one document finishes passing document reading position L1, contact glass 210 is controlled such that the left end thereof returns to reference position L0 before the time when the end portion of a next document arrives at document reading position L1. Movement of contact glass 210 is controlled as described above, for each image reading processing for one document.

Therefore, as a result of the operation of contact glass 210 described above, image processing portion 240 can obtain image data including low noise (for example, stripe noise), even if a foreign matter such as paper dust or an adhesive substance is present on contact glass 210.

It is noted that white background screen 130 included in ADF 100 is arranged to cover a part of a range where contact glass 210 can move (for example, a range from reference position L0 to a position between position L1 and position L2).

Generally, a speed at which a document is transported from ADF 100 (hereinafter, also referred to as document transportation speed) is set based on a set magnification rate desired by a user, such that the speed varies relative to a reading speed of image processing portion 240. Here, the set magnification rate desired by the user is assumed, for example, as 120% or 75%. Based on the set magnification rate desired by the user and the set document transportation speed, image processing portion 240 performs the image processing such as enlargement and reduction of image data with respect to the direction of transportation of the document.

In the image reading processing, speed modification processing or electronic magnification processing is performed.

According to the speed modification processing, the document transportation speed in a vertical scanning direction is changed relative to the reading speed of image processing portion 240, in accordance with the set magnification rate desired by the user.

According to the electronic magnification processing, the document transportation speed in a vertical scanning direction is set identical to the reading speed of image processing portion 240, and image data read by image processing portion 240 is interpolated or thinned based on the set magnification rate desired by the user, so as to enlarge or reduce the image data.

Image forming portion 400 attains a function to perform processing for printing image data read by image reading unit 200, for example, on paper (hereinafter, also referred to as print processing). Then, image forming portion 400 outputs the printed paper to the outside. Image forming portion 400 may be any apparatus such as a color laser printer, a monochrome laser printer, an ink jet printer, or the like, so long as it forms an image on paper based on given data.

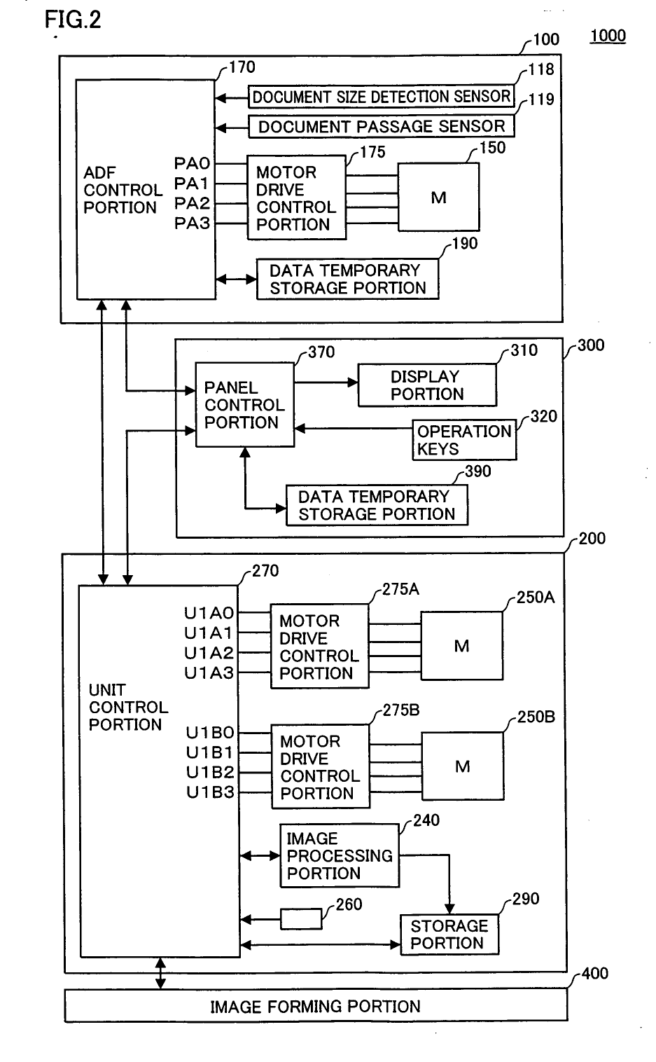

Referring to FIG. 2, image forming apparatus 1000 includes ADF 100, image reading unit 200, an operation panel unit 300, and image forming portion 400.

In FIG. 1, operation panel unit 300 is attached, for example, to image reading unit 200. Operation panel unit 300 includes a panel control portion 370, a display portion 310, operation keys 320, and a data temporary storage portion 390.

Panel control portion 370 attains a function to perform various types of processing for each portion within operation panel unit 300, operational processing, and the like. Panel control portion 370 may be implemented by any of a microprocessor, an FPGA (Field Programmable Gate Array) which is an LSI (Large Scale Integration) capable of being programmed, an ASIC (Application Specific Integrated Circuit) which is an integrated circuit designed and manufactured for a specific application, or other circuit attaining an operational function.

Display portion 310 attains a function to display various types of information to the user by using characters, images, and the like. Display portion 310 displays characters and images based on a control instruction transmitted from panel control portion 370. Display portion 310 attains a touch panel function such that the user can directly touch a screen to input information. Display portion 310 may be implemented by any of a liquid crystal display (LCD), an FED (Field Emission Display), an organic electroluminescence display, dot matrix, and display equipment adapted to other image display schemes.

Operation keys 320 serve to give instructions to image forming apparatus 1000 by a pressing-down operation by the user. The user presses down operation keys 320, for example, in order to input the set magnification rate described previously. Information input through operation keys 320 is transmitted to panel control portion 370.

Data temporary storage portion 390 is used as a work memory accessed by panel control portion 370 and temporarily storing data. Data temporary storage portion 390 may be implemented by any of an RAM (Random Access memory) capable of temporarily storing data, an SRAM (Static Random Access Memory), a DRAM (Dynamic Random Access Memory), an SDRAM (Synchronous DRAM), a DDR-SDRAM (Double Data Rate SDRAM) attaining a data transfer function at high-speed called double data rate mode, an RDRAM (Rambus Dynamic Random Access memory) which is a DRAM adopting a high-speed interface technology developed by Rambus Inc., a Direct-RDRAM (Direct Rambus Dynamic Random Access memory), and other circuit configured to store and hold data in a volatile manner.

ADF 100 includes an ADF control portion 170, a motor drive control portion 175, drive pulse motor 150, document size detection sensor 118, document passage sensor 119, and a data temporary storage portion 190.

Document size detection sensor 118 detects a document FD length of document group 115 set on paper feed tray 110, and transmits a document FD length signal indicating the document FD length to ADF control portion 170.

If the document is passing the sensor, document passage sensor 119 continues to transmit to ADF control portion 170 a signal indicating that the document is passing.

ADF control portion 170 attains a function to perform various types of processing for each portion within ADF 100, operational processing, and the like. As ADF control portion 170 is similar to panel control portion 370, detailed description will not be repeated. ADF control portion 170 receives the document FD length signal from document size detection sensor 118, to obtain the document FD length. ADF control portion 170 is connected to motor drive control portion 175 via four signal lines transmitting excitation signals PA0 to PA3 respectively. ADF control portion 170 transmits a control instruction using excitation signals PA0 to PA3 (hereinafter, also referred to as motor control instruction PA) to motor drive control portion 175.

Motor drive control portion 175 is connected to drive pulse motor 150. Motor drive control portion 175 drives drive pulse motor 150 in response to motor control instruction PA.

ADF control portion 170 varies the document transportation speed in accordance with the set magnification rate desired by the user. Specifically, ADF control portion 170 sends to motor drive control portion 175 motor control instruction PA for transporting the document at a document transportation speed in accordance with the set magnification rate desired by the user (hereinafter, also referred to as set-magnification-rate-adapted speed). Motor control instruction PA represents a control instruction using excitation signals PA0 to PA3 set to a frequency in accordance with the set-magnification-rate-adapted speed.

Motor drive control portion 175 drives drive pulse motor 150 in response to motor control instruction PA.

Drive pulse motor 150 controls paper feed roller 120A, separation roller 120B and pre-reading roller 120C under the control of motor drive control portion 175, so as to transport the document at the set-magnification-rate-adapted speed.

Data temporary storage portion 190 is used as a work memory accessed by ADF control portion 170 and temporarily storing data.

As data temporary storage portion 190 is similar to data temporary storage portion 390, detailed description will not be repeated

Image reading unit 200 includes a unit control portion 270, a motor drive control portion 275A, drive pulse motor 250A, motor drive control portion 275B, drive pulse motor 250B, image processing portion 240, reference position detection sensor 260, and a storage portion 290.

Unit control portion 270 attains a function to perform various types of processing for each portion within image reading unit 200, operational processing, and the like. As unit control portion 270 is similar to panel control portion 370, detailed description will not be repeated. Unit control portion 270 is connected to ADF control portion 170 within ADF 100 via a signal line, and capable of data communication.

Unit control portion 270 transmits to ADF control portion 170 information on the set-magnification-rate-adapted speed, information on an operation mode such as one-sided/two-sided mode, a control instruction, and the like during the image reading processing. ADF control portion 170 receives the information on the set-magnification-rate-adapted speed, the information on the operation mode, the control instruction, and the like, and sends a control instruction in accordance with the control instruction to each portion within ADF 100.

Unit control portion 270 is connected to motor drive control portion 275A via four signal lines transmitting excitation signals U1A0 to U1A3 respectively. Unit control portion 270 sends a control instruction using excitation signals U1A0 to U1A3 (hereinafter, also referred to as motor control instruction U1A) to motor drive control portion 275A. Motor control instruction U1A represents a control instruction using excitation signals U1A0 to U1A3 set to a frequency in accordance with the set-magnification-rate-adapted speed.

Motor drive control portion 275A is connected to drive pulse motor 250A. Motor drive control portion 275A drives drive pulse motor 250A in response to motor control instruction U1A.

Drive pulse motor 250A controls contact glass 210 such that it moves in the left-right direction at a constant speed, under the control of motor drive control portion 275A.

Unit control portion 270 is connected to motor drive control portion 275B via four signal lines transmitting excitation signals U1B0 to U1B3 respectively. Unit control portion 270 sends a control instruction using excitation signals U1B0 to U1B3 (hereinafter, also referred to as motor control instruction U1B) to motor drive control portion 275B.

Motor drive control portion 275B is connected to drive pulse motor 250B. Motor drive control portion 275B drives drive pulse motor 250B in response to motor control instruction U1B.

Drive pulse motor 250B moves reading slider unit 220 in the left-right direction under the control of motor drive control portion 275B. During the image reading processing utilizing ADF 100, reading slider unit 220 is stopped at document reading position L1.

Unit control portion 270 is connected to image processing portion 240 and reference position detection sensor 260, and performs data communication.

Storage portion 290 stores a program causing unit control portion 270 and image processing portion 240 to perform processing which will be described later, data on a reading speed of image processing portion 240, and a variety of programs and data. Storage portion 290 is accessed by unit control portion 270 and image processing portion 240.

Storage portion 290 is implemented by a hard disk capable of storing data of a large capacity. It is noted that storage portion 290 is not limited to the hard disk, and may be implemented by a medium capable of holding data without power supply (such as a flash memory).

In other words, storage portion 290 may be implemented by any of an EPROM (Erasable Programmable Read Only Memory) allowing erasing and writing over and over again, an EEPROM (Electronically Erasable and Programmable Read Only Memory) allowing contents to be programmed electrically, a UV-EPROM (Ultra-Violet Erasable Programmable Read Only Memory) allowing stored content to be erased and rewritten over and over again by using ultraviolet, and a circuit configured to store and hold data in a non-volatile manner.

Unit control portion 270 is connected to image forming portion 400. Unit control portion 270 transmits a control instruction for causing image forming portion 400 to perform print processing and data necessary for the print processing.

Upon receiving the control instruction, image forming portion 400 prints on paper an image in accordance with the received data.

In the following, an apparatus constituted of ADF 100, image reading unit 200 and operation panel unit 300 is also referred to as an image reading apparatus. In the present invention, processing without using image forming portion 400 among the processing performed by each of ADF 100, image reading unit 200 and operation panel unit 300 can be performed by the image reading apparatus alone.

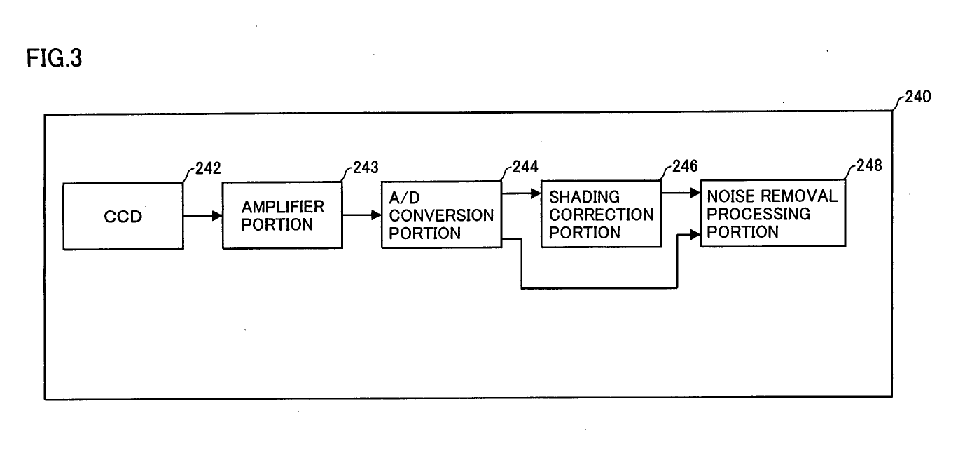

Referring to FIG. 3, image processing portion 240 includes CCD (Charge Coupled Devices) 242, an amplifier portion 243, an A/D conversion portion 244, a shading correction portion 246, and a noise removal processing portion 248.

CCD 242 converts light input from lens 232 to an electric signal, and outputs the electric signal to amplifier portion 243.

Amplifier portion 243 amplifies the input electric signal, and outputs the amplified electric signal to A/D conversion portion 244.

A/D conversion portion 244 converts the input electric signal to digital data, and outputs the digital data to shading correction portion 246 during shading correction processing which will be described later.

Shading correction portion 246 performs the shading correction processing for correcting sensitivity of CCD 242 based on the input digital data when use of image forming apparatus 1000 is started or every prescribed time.

A/D conversion portion 244 outputs the converted digital data to noise removal processing portion 248 while the shading correction processing is not performed.

If the image based on the input digital data includes noise due to a foreign matter or the like not larger than a prescribed size (hereinafter, also referred to as a noise-removable image), noise removal processing portion 248 performs noise removal processing on the noise-removable image for removing the noise. Here, the noise removal processing represents, for example, processing such as filtering processing utilizing data in a peripheral area of a noise portion. Thereafter, noise removal processing portion 248 causes storage portion 290 to store the image data from which noise has been removed.

If the image based on the input digital data includes noise due to a foreign matter or the like of a size not smaller than a prescribed size or includes no noise, noise removal processing portion 248 does not perform the noise removal processing in order to avoid overall deterioration of the image, but causes storage portion 290 to store the image data. In addition, noise removal processing portion 248 transmits the obtained image data to unit control portion 270.

Processing for detecting a foreign matter causing noise of a size not smaller than the prescribed size (hereinafter, also referred to as large foreign matter) is performed during a period in which the image reading processing is not performed, that is, during a period in which contact glass 210 returns from position L2 to reference position L0. In the processing for detecting a large foreign matter, an image at document reading position L1 within white background screen 130 through contact glass 210 (hereinafter, also referred to as large foreign matter detection image) is input to image processing portion 240. Image processing portion 240 transmits data of the input large foreign matter detection image to unit control portion 270. Unit control portion 270 monitors the data of the input large foreign matter detection image so as to detect a large foreign matter on contact glass 210.

A position of the large foreign matter on contact glass 210 can be calculated, for example, in such a manner that unit control portion 270 counts the number of pulses of excitation signals U1A0 to U1A3 having a frequency set in order to cause contact glass 210 to move at a desired speed.

Unit control portion 270 calculates a position of the large foreign matter on contact glass 210, so that an area where contact glass 210 moves is set to an area where a large foreign matter is not present. Therefore, performance in removing noise in an image can be enhanced.

A method of setting a moving speed of contact glass 210 characterizing the present invention will now be described.

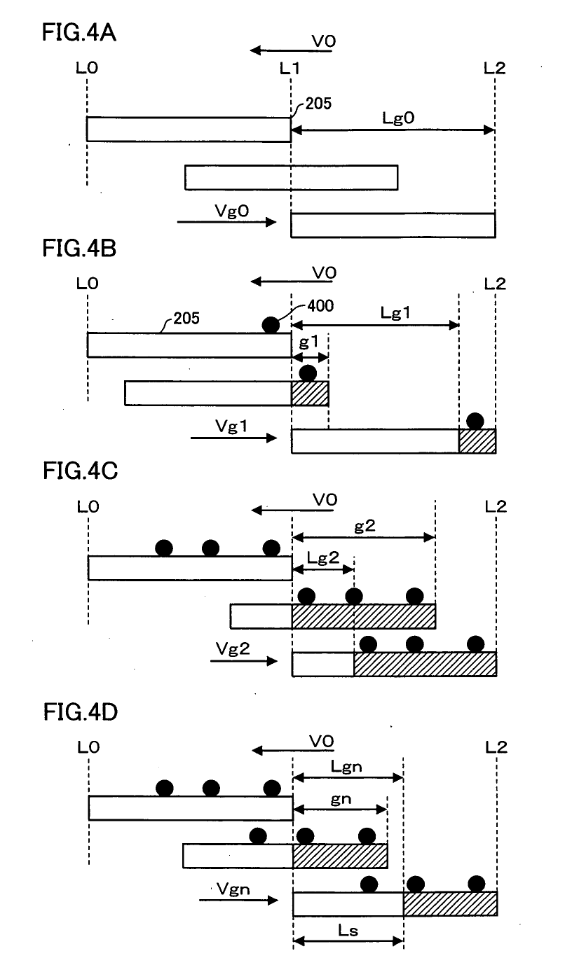

Referring to FIG. 4, FIG. 4(A) shows an example in which a large foreign matter on contact glass 210 is not detected as a result of the processing for detecting a large foreign matter described previously. Here, a glass movement effective length Lg0 (mm) represents a maximum width in which contact glass 210 can move. Data of glass movement effective length Lg0 is stored in storage portion 290 in advance. V0 represents a document transportation speed that is initially set.

In the example of FIG. 4(A), the image reading processing is performed while contact glass 210 is moved within a range of glass movement effective length Lg0. Contact glass 210 is moved by a distance of glass movement effective length Lg0 during a period from the time when reading of the document is started until the time when reading is completed (hereinafter, also referred to as a document reading time). If a length of the document in the vertical scanning direction is denoted as L0 (mm) and a reading speed of image processing portion 240 is denoted as V0 (mm/s), a document reading time T0 is calculated as shown in Equation (1) below.
T0 (s)=L0 (mm)/V0 (mm/s) (1)
A moving speed Vg0 (mm/s) of contact glass 210 (hereinafter, also referred to as a glass moving speed) is calculated as shown in Equation (2) below.
Vg0 (mm/s)=Lg0 (mm)/T0 (s) (2)

FIG. 4(B) shows an example in which a large foreign matter 400 on contact glass 210 is detected as a result of the processing for detecting a large foreign matter described previously. Here, the image reading processing is performed by utilizing a portion where the large foreign matter on contact glass 210 is not present. Therefore, a maximum width in which contact glass 210 can move is set to glass movement effective length Lg1 (mm) by unit control portion 270.

Contact glass 210 is moved to the right by a width g1 where the large foreign matter is present, under the control of unit control portion 270 before the image reading processing is started. Contact glass 210 is moved by a distance of glass movement effective length Lg1 during the document reading time. Here, glass moving speed Vg1 (mm/s) is calculated as shown in Equation (3) below.
Vg1 (mm/s)=Lg1 (mm)/T0 (s) (3)
It is noted that Vg1 is smaller than Vg0 (Vg1<Vg0), because Lg1 is smaller than Lg0 (Lg1<Lg0).

FIG. 4(C) shows an example in which a plurality of large foreign matters on contact glass 210 are detected as a result of the processing for detecting a large foreign matter described previously. Here, the image reading processing is performed by utilizing a portion where the plurality of large foreign matters on contact glass 210 are not present. Therefore, a maximum width in which contact glass 210 can move is set to glass movement effective length Lg2 (mm) by unit control portion 270.

Contact glass 210 is moved to the right by a width g2 where the plurality of large foreign matters are present, under the control of unit control portion 270 before the image reading processing is started. Contact glass 210 is moved by a distance of glass movement effective length Lg2 during the document reading time. Here, glass moving speed Vg2 (mm/s) is calculated as shown in Equation (4) below.
Vg2 (mm/s)=Lg2 (mm)/T0 (s) (4)
It is noted that Vg2 is smaller than Vg0 (Vg2<Vg0), because Lg2 is smaller than Lg0 (Lg2<Lg0).

In other words, as glass movement effective length Lgn is smaller, glass moving speed Vgn is slower. When the glass moving speed is slower than a prescribed speed, lower stability in speed, vibration of contact glass 210 and noise are considerably caused.

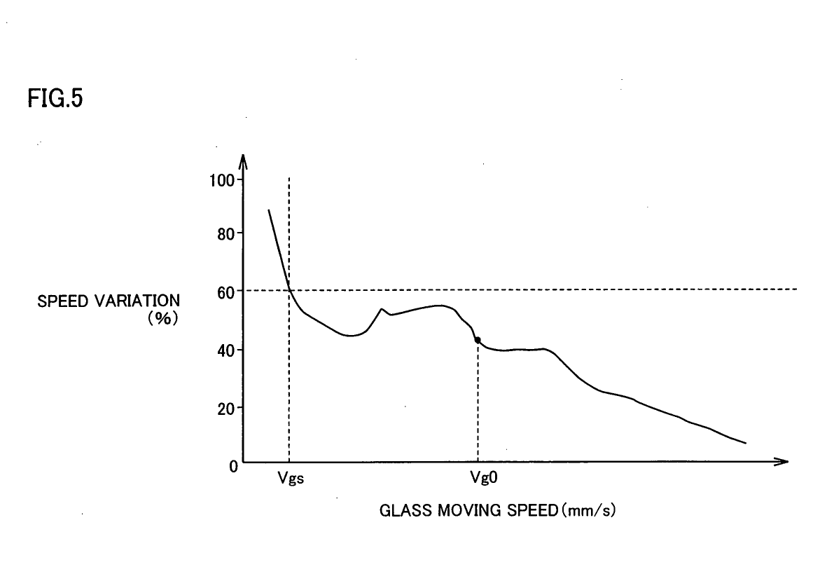

The glass moving speed in FIG. 5 is varied, using a two-phase excitation method. Here, it is assumed that speed variation is set, for example, to 10%. Then, even if the glass moving speed is set to 10 (mm/s), the glass moving speed is set to a speed within a range including 10% margin (9 to 11 (mm/s)).

Referring to FIG. 5, as the glass moving speed is slower, the speed variation is larger. Here, in order to maintain the noise removal performance in the noise removal processing at a level not lower than a prescribed level, it is assumed that the speed variation should be set, for example, to not higher than 60%.

Therefore, when glass movement effective length Lgn is set to approximately ¼ of the example shown in FIG. 4(A) (the example shown in FIG. 4(C)) and when the glass moving speed is set to not higher than speed Vgs which is approximately ¼ of initial speed Vg0, the speed variation exceeds 60% and the noise removal performance in the noise removal processing becomes lower than the prescribed level. In the following, speed Vgs may also be referred to as a glass movement limit speed Vgs. When the glass moving speed is slower than glass movement limit speed Vgs, lower stability in speed, vibration of contact glass 210 and noise are considerably caused.

It is noted that the graph in FIG. 5 represents merely one example, and property of the graph is varied depending on a variety of parameters such as a reading speed of image processing portion 240, a configuration for driving contact glass 210, a method of driving contact glass 210, the noise removal processing, and the like. Meanwhile, no difference is produced in the property that the noise removal performance in the noise removal processing is lowered as the glass moving speed is slower.

If the noise removal performance in the noise removal processing is lowered, the noise caused by a foreign matter smaller than the large foreign matter, that could be removed through the noise removal processing prior to lowering in the glass moving speed, cannot completely be removed. Accordingly, quality of the image obtained by image processing portion 240 is lowered.

In order to solve this problem, according to the present invention, as shown in FIG. 4(D), glass movement effective length Lgn is not permitted to be set to a value smaller than a prescribed value Ls. Specifically, glass moving speed Vgn is not permitted to attain a speed slower than glass movement limit speed Vgs. In this manner, lower stability in speed, vibration of contact glass 210, noise, and lowering in the noise removal performance in the noise removal processing due to slower glass moving speed can be prevented.

If the glass movement effective length is restricted to a value not smaller than a prescribed value, an area where a large foreign matter is adhered out of contact glass 210 may also be used. In such a case, stripe noise cannot completely be removed. As the noise removal performance in the noise removal processing for removing the noise caused by a foreign matter smaller than the large foreign matter can be maintained, noise in the image can be mitigated.

It is noted that an exemplary method of using an area where a large foreign matter is not adhered out of contact glass 210 includes the following. Specifically, when glass moving speed Vgn is smaller than glass movement limit speed Vgs, the document transportation speed is increased. That is, a relative velocity based on glass moving speed Vgn and the document transportation speed is kept at a speed not slower than a prescribed speed. Then, electronic magnification processing in accordance with the modified document transportation speed is performed in the image reading processing.

With such a method, however, quality of the image obtained by image processing portion 240 through the electronic magnification processing by increasing the document transportation speed may be different to some degree from quality of the image obtained by image processing portion 240 without modifying the document transportation speed. Therefore, the present invention is effective for a user who desires reading of a plurality of documents with the same quality even if there is stripe noise or the like, for example.

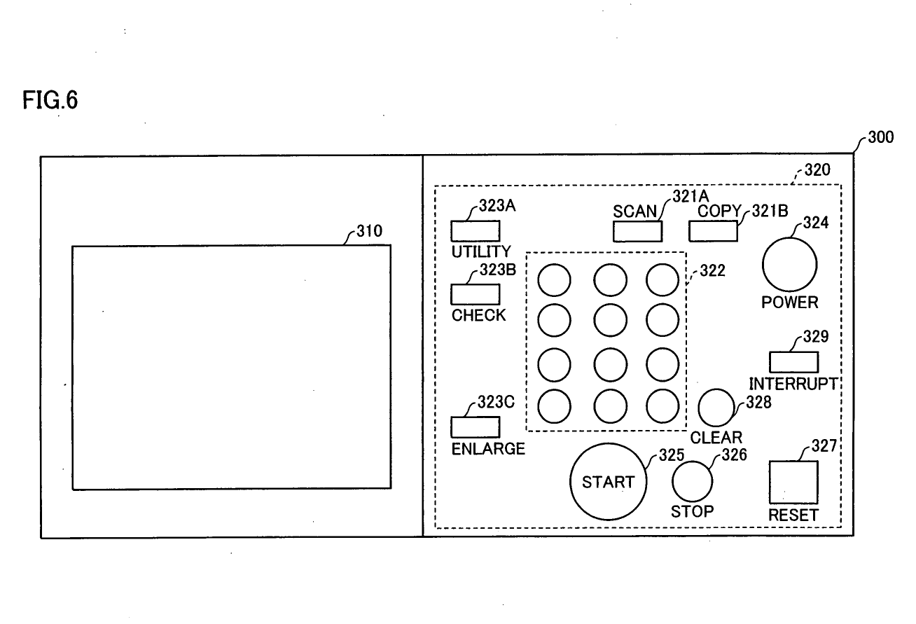

Referring to FIG. 6, operation panel unit 300 includes display portion 310 and operation keys 320. Display portion 310 attains a touch panel function as described previously.

Operation keys 320 include a plurality of keys which will be described below. Information on the key pressed down by the user (hereinafter, also referred to as pressed-down key information) among the plurality of keys is transmitted to panel control portion 370. Panel control portion 370 transmits the received pressed-down key information to unit control portion 270. Unit control portion 270 performs various types of processing in accordance with the received pressed-down key information.

Operation keys 320 include a scan mode key 321A, a copy mode key 321B, a numeric keypad 322, a utility key 323A, a setting check key 323B, and an enlarged view key 323C.

Scan mode key 321A is a key for setting image forming apparatus 1000 to a scan mode. Copy mode key 321B is a key for setting image forming apparatus 1000 to a copy mode. Numeric keypad 322 is a key for setting copy count or inputting various numeric values.

Utility key 323A is a key for displaying an image corresponding to a special mode such as a user setting mode, a total check mode, a serviceperson maintenance mode, or the like on display portion 310. The user setting mode represents a mode for modifying various types of setting in image forming apparatus 1000, in accordance with preference of the user. The total check mode represents a mode for displaying various counter values. The serviceperson maintenance mode represents a mode for more detailed setting in image forming apparatus 1000 permitted solely to a specific user.

Setting check key 323B is a key for displaying a list of each mode that has been set on display portion 310. Enlarged view key 323C is a key for switching between processing for enlarging an image displayed on display portion 310 and processing for not doing so.

Operation keys 320 further include a power key 324, a start key 325, a stop key 326, a reset key 327, a clear key 328, and an interrupt key 329.

Power key 324 is a key for switching between power-on and power-off of image forming apparatus 1000. Start key 325 is a key for starting the document reading processing or the print processing. Stop key 326 is a key for stopping a JOB (job) during processing such as the document reading processing or the print processing. Reset key 327 is a key for canceling all modes set in image forming apparatus 1000 or for discarding the JOB that has been stopped. Clear key 328 is a key for initializing copy count and various numeric values that have been set. Interrupt key 329 is a key for setting or resetting the interrupt mode.

Initial setting processing performed before starting one JOB (for example, processing for copying 100 documents) will now be described.

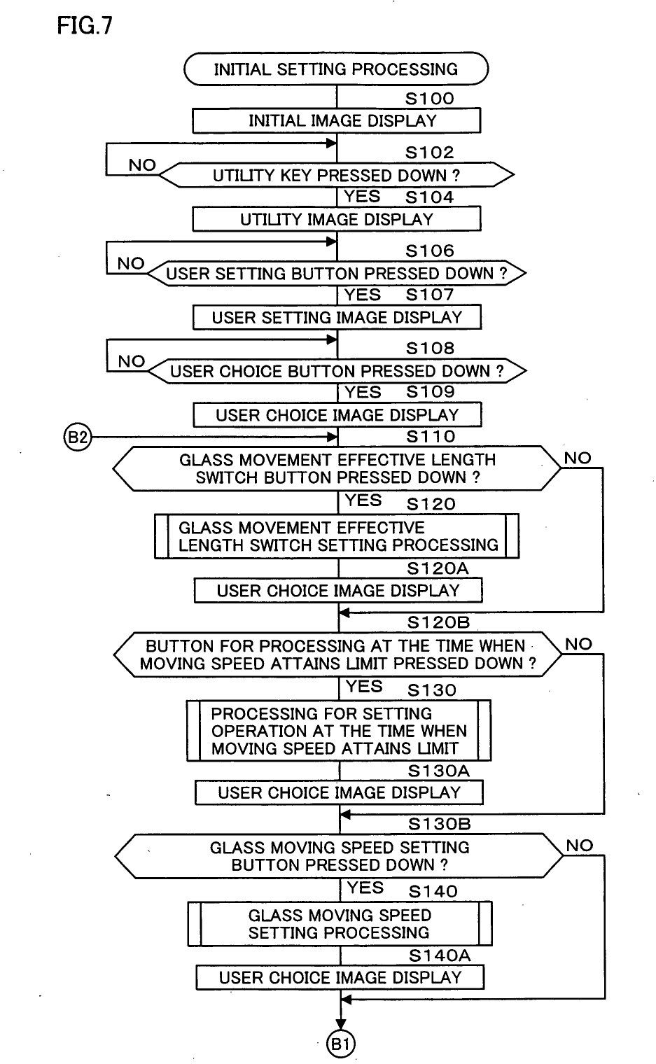

Referring to FIG. 7, at step S100, panel control portion 370 causes display portion 310 to display an initial image in response to a control instruction from unit control portion 270. The initial image is normally displayed on display portion 310 when image forming apparatus 1000 is turned on.

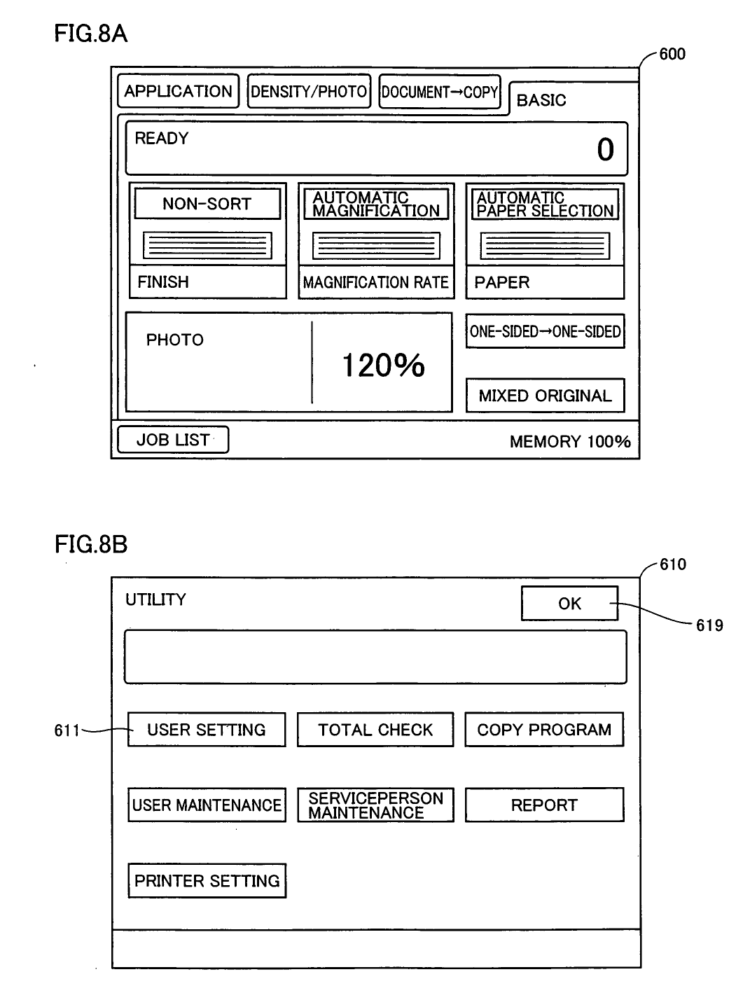

FIG. 8(A) shows an exemplary initial image 600.

Referring again to FIG. 7, after the processing at step S100, the process proceeds to step S102.

At step S102, unit control portion 270 determines whether or not the user has pressed down utility key 323A. If it is determined as YES at step S102, the process proceeds to step S104. If it is determined as NO at step S102, the process at step S102 is repeated.

At step S104, panel control portion 370 causes display portion 310 to display a utility image in response to a control instruction from unit control portion 270.

Referring again to FIG. 8, FIG. 8(B) shows an exemplary utility image 610. In utility image 610, a plurality of button images are arranged. When the user presses down (touches) any one of the plurality of button images, panel control portion 370 transmits information on the pressed-down button image (hereinafter, also referred to as pressed-down button information) to unit control portion 270. Unit control portion 270 performs various types of processing in accordance with the received pressed-down button information. This is also the case with button images arranged in various images which will be described below. In utility image 610, a user setting button image 611 and a setting end button image 619 are arranged. Setting end button image 619 is a button image for ending the setting processing in utility image 610.

Referring again to FIG. 7, after the processing at step S104, the process proceeds to step S106.

At step S106, unit control portion 270 determines whether or not the user has pressed down user setting button image 611. If it is determined as YES at step S106, the process proceeds to step S107. If it is determined as NO at step S106, the process at step S106 is repeated.

At step S107, panel control portion 370 causes display portion 310 to display a user setting image in response to a control instruction from unit control portion 270.

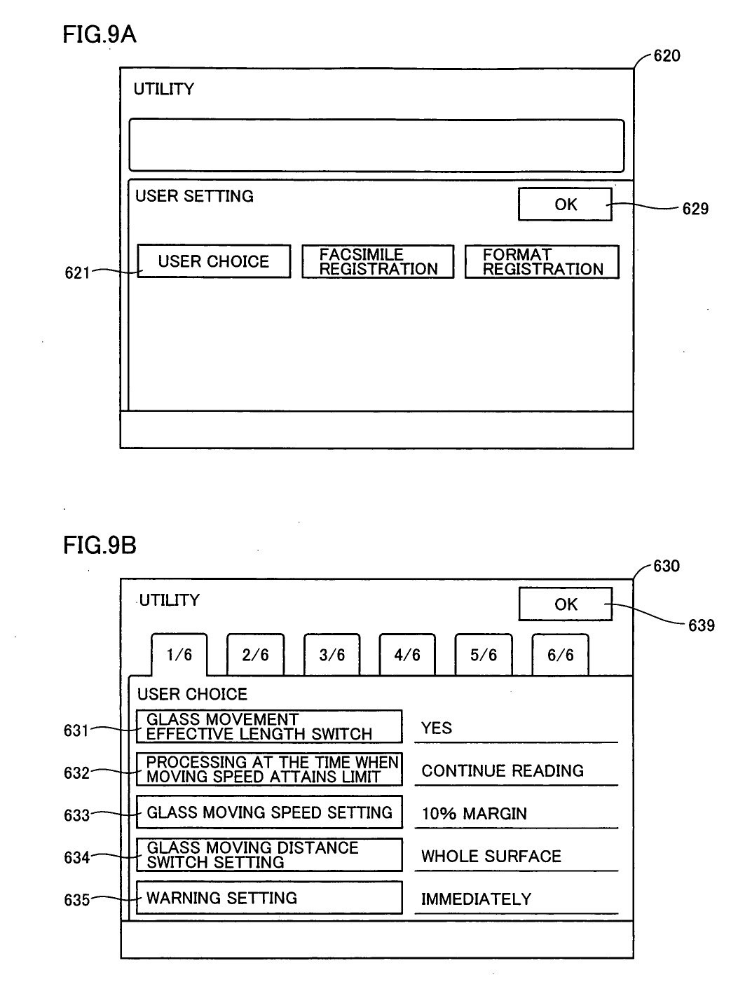

FIG. 9(A) shows an exemplary user setting image 620. In user setting image 620, a plurality of button images are arranged. In user setting image 620, a user choice button image 621 and a setting end button image 629 are arranged. Setting end button image 629 is a button image for ending the setting processing in user setting image 620.

Referring again to FIG. 7, after the processing at step S107, the process proceeds to step S108.

At step S108, unit control portion 270 determines whether or not the user has pressed down user choice button image 621. If it is determined as YES at step S108, the process proceeds to step S109. If it is determined as NO at step S108, the process at step S108 is repeated.

At step S109, panel control portion 370 causes display portion 310 to display a user choice image in response to a control instruction from unit control portion 270. The user choice image is an image for making various types of setting related to movement of the glass in the present invention.

Referring again to FIG. 9, FIG. 9(B) shows an exemplary user choice image 630. In the present embodiment, an image set for each of a plurality of menu layers is displayed on display portion 310, so that detailed setting can be made. In the present embodiment, an example in which an image displayed on display portion 310 has been switched from user setting image 620 to user choice image 630 is shown. If the number of items to be set in detail is small, an image in which images for such items are arranged in a free space within user setting image 620 may be displayed on display portion 310.

In user choice image 630, a glass movement effective length switch button image 631, a moving speed limit processing button image 632, a glass moving speed setting button image 633, a glass moving distance switch setting button image 634, a warning setting button image 635, and a setting end button image 639 are arranged. Each button image will be described in detail later.

Referring again to FIG. 7, after the processing at step S109, the process proceeds to step S110.

At step S110, unit control portion 270 determines whether or not the user has pressed down glass movement effective length switch button image 631. Glass movement effective length switch button image 631 is a button image for displaying an image for setting whether to switch the glass movement effective length if the glass moving speed is out of a range of allowable speed.

If it is determined as YES at step S110, the process proceeds to step S120. If it is determined as NO at step S110, the process proceeds to S120B which will be described later.

At step S120, processing for glass movement effective length switch setting is performed.

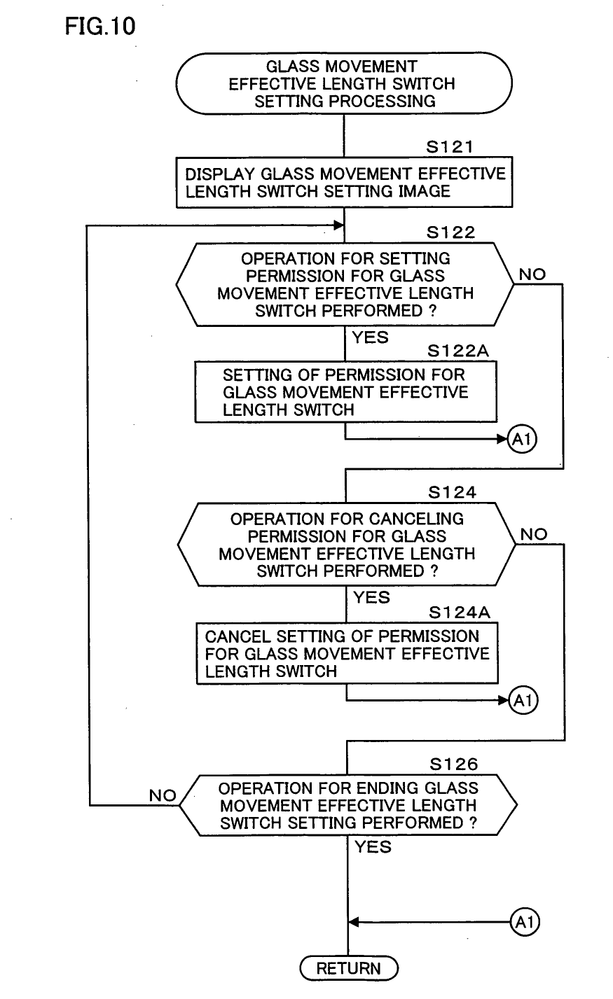

FIG. 10 is a flowchart of the processing for glass movement effective length switch setting.

Referring to FIG. 10, at step S121, panel control portion 370 causes display portion 310 to display a glass movement effective length switch setting image in response to a control instruction from unit control portion 270.

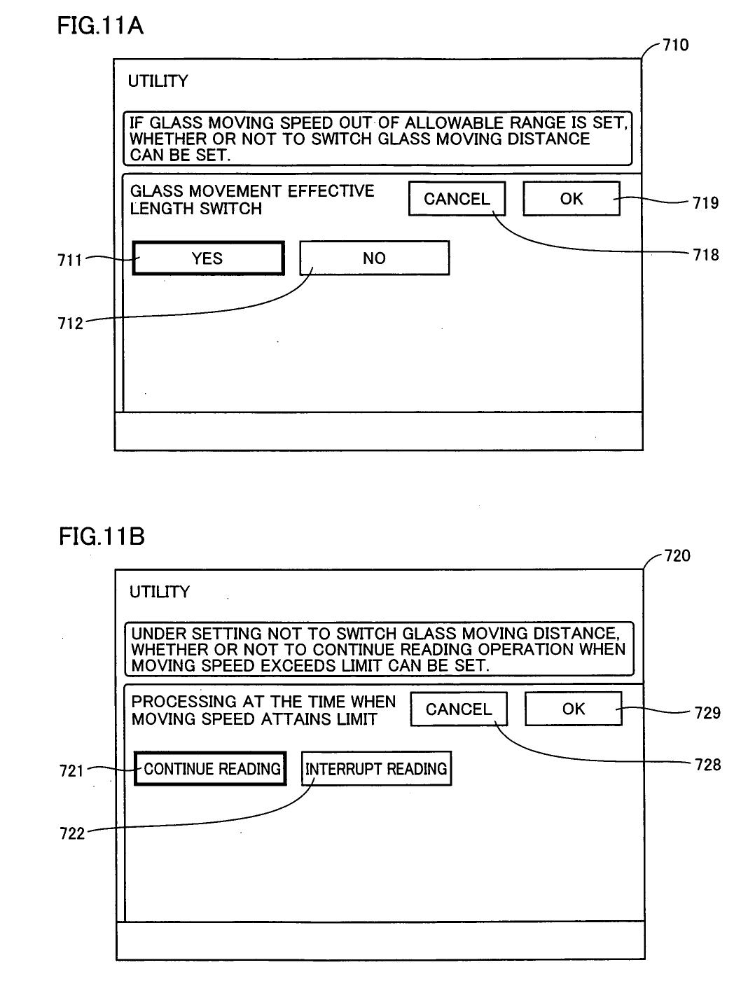

FIG. 11(A) shows an exemplary glass movement effective length switch setting image 710. In glass movement effective length switch setting image 710, button images 711, 712, 718, and 719 are arranged.

Button image 711 is a button image for permitting switching of a glass movement effective length. Button image 712 is a button image for not permitting switching of a glass movement effective length. Button image 719 is a button image for setting processing corresponding to button image 711 or button image 712. Button image 718 is a button image for ending the processing for glass movement effective length switch setting.

Referring again to FIG. 10, after the processing at step S121, the process proceeds to step S122.

At step S122, whether or not an operation for setting permission for switching the glass movement effective length has been performed is determined. Specifically, unit control portion 270 determines whether or not the user has pressed down button image 719 after the user pressed down button image 711. If it is determined as YES at step S122, the process proceeds to step S122A. If it is determined as NO at step S122, the process proceeds to step S124.

At step S122A, setting for permission for switching the glass movement effective length is made. Specifically, unit control portion 270 sets a glass movement effective length switch permission flag stored in storage portion 290 to on. The glass movement effective length switch permission flag represents a flag for permitting switching of the glass movement effective length if it is set to on. It is noted that the glass movement effective length switch permission flag is set to off at an initial state. Thereafter, the processing for glass movement effective length switch setting ends, and the process proceeds to step S120A following step S120 in FIG. 7.

At step S124, whether or not an operation for setting cancellation of permission for switching the glass movement effective length has been performed is determined. Specifically, unit control portion 270 determines whether or not the user has pressed down button image 719 after the user pressed down button image 712. If it is determined as YES at step S124, the process proceeds to step S124A. If it is determined as NO at step S124, the process proceeds to step S126.

At step S124A, setting of permission for switching the glass movement effective length is cancelled. Specifically, unit control portion 270 sets the glass movement effective length switch permission flag to off. An example in which the processing at step S124A is performed includes such a case that the user desires reading of a plurality of documents with the same quality even if there is stripe noise or the like. Thereafter, the processing for glass movement effective length switch setting ends, and the process proceeds to step S120A following step S120 in FIG. 7.

At step S126, whether or not an operation for ending the glass movement effective length switch setting has been performed is determined. Specifically, unit control portion 270 determines whether or not the user has pressed down button image 718. If it is determined as YES at step S126, the processing for glass movement effective length switch setting ends, and the process proceeds to step S120A following step S120 in FIG. 7. If it is determined as NO at step S126, the process at step S122 is repeated.

Referring again to FIG. 7, after the processing at step S120, the process proceeds to step S120A.

At step S120A, the user choice image is displayed on display portion 310 through the processing similar to that at step S109. In the user choice image, what has been set through the processing for glass movement effective length switch setting is displayed. Thereafter, the process proceeds to step S120B.

At step S120B, unit control portion 270 determines whether or not the user has pressed down moving speed limit processing button image 632. Moving speed limit processing button image 632 is a button image for displaying an image for setting whether reading of a document should be continued or interrupted if the glass moving speed is out of a range of allowable speed and the glass movement effective length is not switched. In the following, a case in which the glass moving speed is out of the range of allowable speed and the glass movement effective length is not switched is also referred to as case A.

If it is determined as YES at step S120B, the process proceeds to step S130. If it is determined as NO at step S120B, the process proceeds to S130B which will be described later.

At step S130, processing for setting an operation at the time when the moving speed attains the limit is performed.

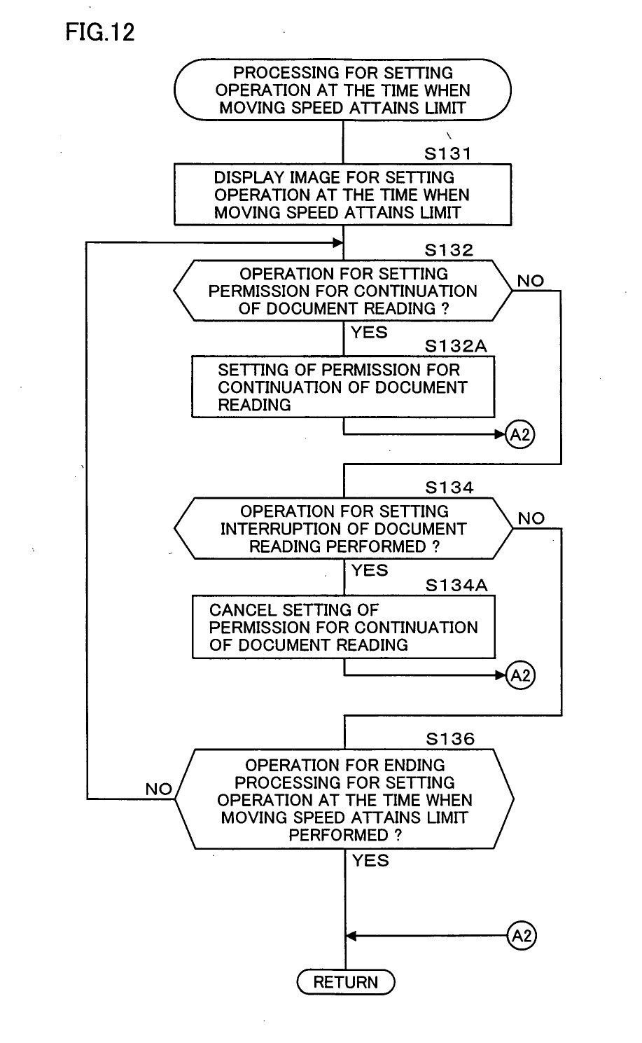

FIG. 12 is a flowchart of the processing for setting an operation at the time when the moving speed attains the limit.

Referring to FIG. 12, at step S131, panel control portion 370 causes display portion 310 to display an image for setting an operation at the time when the moving speed attains the limit in response to a control instruction from unit control portion 270.

Referring again to FIG. 11, FIG. 11(B) shows an exemplary image 720 for setting an operation at the time when the moving speed attains the limit. In image 720 for setting an operation at the time when the moving speed attains the limit, button images 721, 722, 728, and 729 are arranged.

Button image 721 is a button image for continuing reading of a document in case A. Button image 722 is a button image for interrupting reading of a document in case A. Button image 728 is a button image for ending the processing for setting an operation at the time when the moving speed attains the limit. Button image 729 is a button image for setting whether or not reading of the document should be continued in case A.

Referring again to FIG. 12, after the processing at step S131, the process proceeds to step S132.

At step S132, whether or not an operation for setting permission for continuation of document reading in case A has been performed is determined. Specifically, unit control portion 270 determines whether or not the user has pressed down button image 729 after the user pressed down button image 721. If it is determined as YES at step S132, the process proceeds to step S132A. If it is determined as NO at step S132, the process proceeds to step S134.

At step S132A, setting for permission for continuation of reading the document is made. Specifically, unit control portion 270 sets a document reading continuation permission flag stored in storage portion 290 to on. The document reading continuation permission flag is a flag for permitting continuation of reading the document in case A if it is set to on. It is noted that the document reading continuation permission flag is set to off at the initial state. Thereafter, the processing for setting an operation at the time when the moving speed attains the limit ends, and the process proceeds to step S130A following step S130 in FIG. 7.

At step S134, whether or not an operation for setting interruption of reading of the document in case A has been performed is determined. Specifically, unit control portion 270 determines whether or not the user has pressed down button image 729 after the user pressed down button image 722. If it is determined as YES at step S134, the process proceeds to step S134A. If it is determined as NO at step S134, the process proceeds to step S136.

At step S134A, setting of permission for continuation of document reading is cancelled. Specifically, unit control portion 270 sets the document reading continuation permission flag to off. Thereafter, the processing for setting an operation at the time when the moving speed attains the limit ends, and the process proceeds to step S130A following step S130 in FIG. 7.

At step S136, whether or not an operation for ending the processing for setting an operation at the time when the moving speed attains the limit has been performed is determined. Specifically, unit control portion 270 determines whether or not the user has pressed down button image 728. If it is determined as YES at step S136, the processing for setting an operation at the time when the moving speed attains the limit ends, and the process proceeds to step S130A following step S130 in FIG. 7. If it is determined as NO at step S136, the process at step S132 is repeated.

Referring again to FIG. 7, after the processing at step S130, the process proceeds to step S130A.

At step S130A, the user choice image is displayed on display portion 310 through the processing similar to that at step S109. In the user choice image, what has been set through the processing for setting an operation at the time when the moving speed attains the limit is displayed. Thereafter, the process proceeds to step S130B.

At step S130B, unit control portion 270 determines whether or not the user has pressed down glass moving speed setting button image 633. Glass moving speed setting button image 633 is a button image for displaying an image for setting an allowable glass moving speed. If it is determined as YES at step S130B, the process proceeds to step S140. If it is determined as NO at step S130B, the process proceeds to S140B which will be described later.

At step S140, processing for setting the glass moving speed is performed.

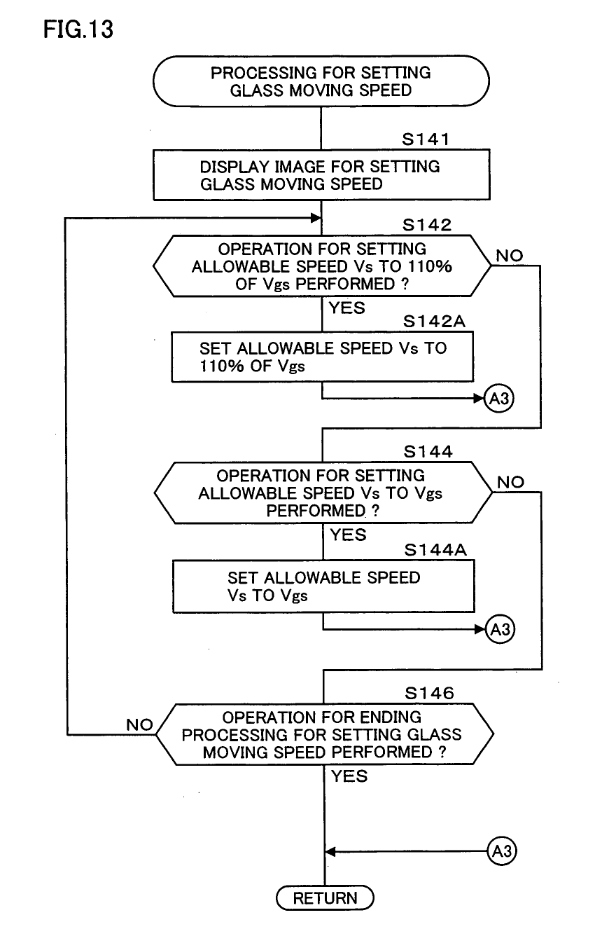

FIG. 13 is a flowchart of the processing for setting the glass moving speed.

Referring to FIG. 13, at step S141, panel control portion 370 causes display portion 310 to display an image for setting the glass moving speed in response to a control instruction from unit control portion 270.

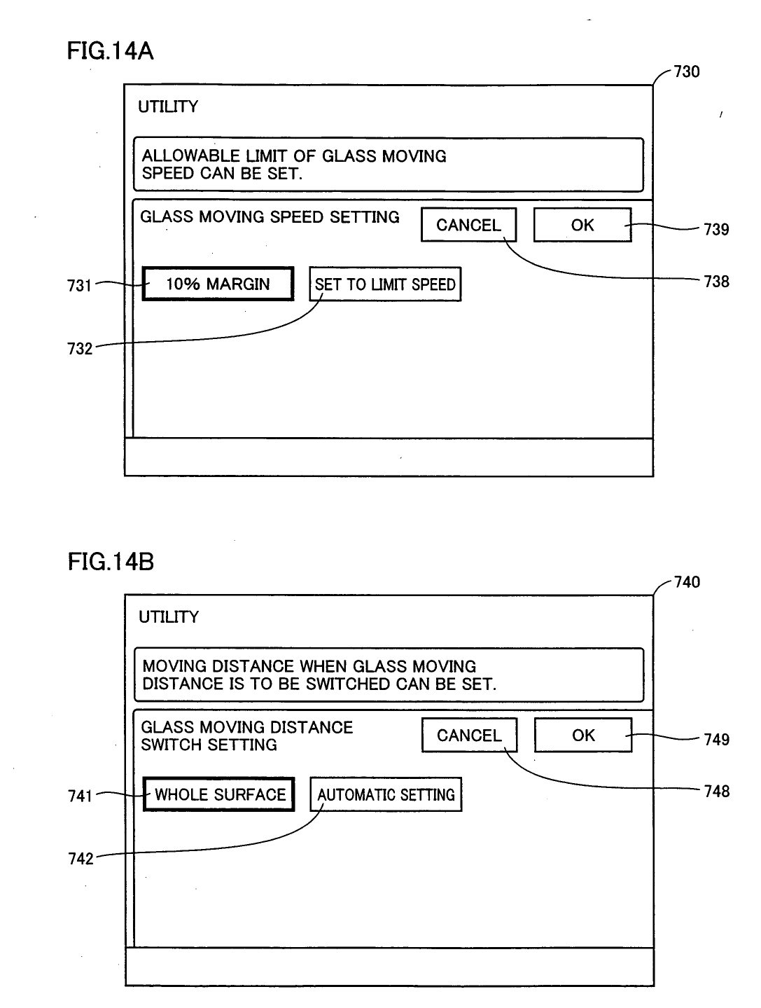

FIG. 14(A) shows an exemplary glass moving speed setting image 730. In glass moving speed setting image 730, button images 731, 732, 738, and 739 are arranged.

Button image 731 is a button image for setting an allowable value Vs of a glass moving speed (hereinafter, also referred to as allowable speed) to a speed with 10% margin of glass movement limit speed Vgs. That is, button image 731 is a button image for setting allowable speed Vs to a speed comparable to 110% of glass movement limit speed Vgs.

Button image 732 is a button image for setting allowable speed Vs to glass movement limit speed Vgs. Button image 738 is a button image for ending the processing for setting the glass moving speed. Button image 739 is a button image for setting allowable speed Vs either to a speed comparable to 110% of glass movement limit speed Vgs or to glass movement limit speed Vgs.

Referring again to FIG. 13, after the processing at step S141, the process proceeds to step S142.

At step S142, whether or not an operation for setting allowable speed Vs to a speed comparable to 110% of glass movement limit speed Vgs has been performed is determined. Specifically, unit control portion 270 determines whether or not the user has pressed down button image 739 after the user pressed down button image 731. If it is determined as YES at step S142, the process proceeds to step S142A. If it is determined as NO at step S142, the process proceeds to step S144.

At step S142A, unit control portion 270 sets allowable speed Vs to a speed comparable to 110% of glass movement limit speed Vgs and causes storage portion 290 to store information on allowable speed Vs. Thereafter, the processing for setting the glass moving speed ends, and the process proceeds to step S140A following step S140 in FIG. 7.

At step S144, whether or not an operation for setting allowable speed Vs to glass movement limit speed Vgs has been performed is determined. Specifically, unit control portion 270 determines whether or not the user has pressed down button image 739 after the user pressed down button image 732. If it is determined as YES at step S144, the process proceeds to step S144A. If it is determined as NO at step S144, the process proceeds to step S146.

At step S144A, unit control portion 270 sets allowable speed Vs to glass movement limit speed Vgs and causes storage portion 290 to store information on allowable speed Vs.

In the present embodiment, the processing for setting allowable speed Vs either to the speed with 10% margin of glass movement limit speed Vgs or to glass movement limit speed Vgs has been described, however, a plurality of types of margins may be set so as to increase options for speed to be set as allowable speed Vs.

Thereafter, the processing for setting the glass moving speed ends, and the process proceeds to step S140A following step S140 in FIG. 7.

At step S146, whether or not an operation for ending the glass moving speed setting has been performed is determined. Specifically, unit control portion 270 determines whether or not the user has pressed down button image 738. If it is determined as YES at step S146, the processing for glass moving speed setting ends, and the process proceeds to step S140A following step S140 in FIG. 7. If it is determined as NO at step S146, the process at step S142 is repeated.

Referring again to FIG. 7, after the processing at step S140, the process proceeds to step S140A.

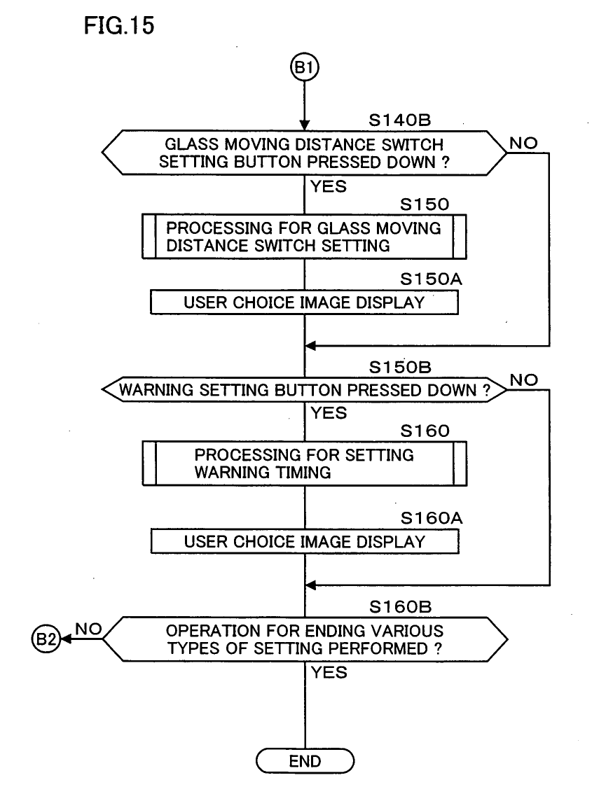

At step S140A, the user choice image is displayed on display portion 310 through the processing similar to that at step S109. In the user choice image, what has been set through the processing for setting the glass moving speed is displayed. Thereafter, the process proceeds to step S140B in FIG. 15.

FIG. 15 is a flowchart of initial setting processing.

Referring to FIG. 15, at step S140B, unit control portion 270 determines whether or not the user has pressed down glass moving distance switch setting button image 634. Glass moving distance switch setting button image 634 is a button image for displaying an image for setting the glass movement effective length when glass movement switching is made.

If it is determined as YES at step S140B, the process proceeds to step S150. If it is determined as NO at step S140B, the process proceeds to S150B which will be described later.

At step S150, processing for glass moving distance switch setting is performed.

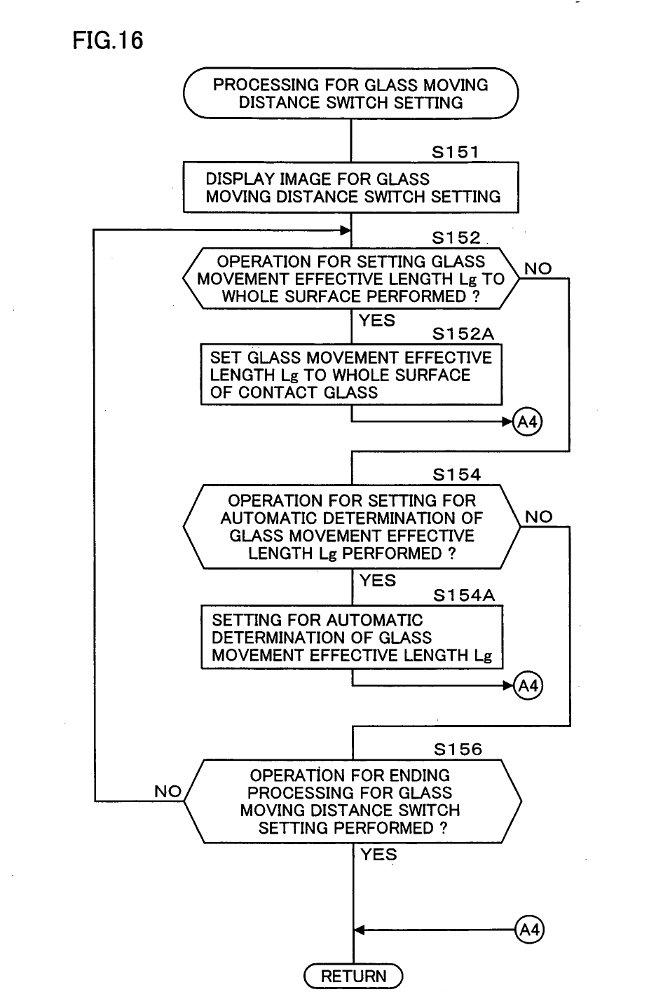

FIG. 16 is a flowchart of the processing for glass moving distance switch setting.

Referring to FIG. 16, at step S151, panel control portion 370 causes display portion 310 to display an image for glass moving distance switch setting in response to a control instruction from unit control portion 270.

Referring again to FIG. 14, FIG. 14(B) shows an exemplary glass moving distance switch setting image 740. In glass moving distance switch setting image 740, button images 741, 742, 748, and 749 are arranged.

Button image 741 is a button image for setting glass movement effective length Lg to whole surface of contact glass 210 regardless of presence of a large foreign matter. Button image 742 is a button image for setting such that glass movement effective length Lg is automatically determined in accordance with a position of a large foreign matter.

Button image 748 is a button image for ending the processing for glass moving distance switch setting. Button image 749 is a button image for setting processing corresponding to button image 741 or button image 742.

Referring again to FIG. 16, after the processing at step S151, the process proceeds to step S152.

At step S152, whether or not an operation for setting glass movement effective length Lg to whole surface of contact glass 210 has been performed is determined. Specifically, unit control portion 270 determines whether or not the user has pressed down button image 749 after the user pressed down button image 741. If it is determined as YES at step S152, the process proceeds to step S152A. If it is determined as NO at step S152, the process proceeds to step S154.

At step S152A, the processing for setting glass movement effective length Lg to whole surface of contact glass 210 is performed. Specifically, unit control portion 270 sets a glass-whole-surface utilization flag stored in storage portion 290 to on. The glass-whole-surface utilization flag is a flag for setting glass movement effective length Lg to whole surface of contact glass 210 if it is set to on. In addition, the glass-whole-surface utilization flag also serves for setting such that glass movement effective length Lg is automatically determined in accordance with a position of a large foreign matter if it is set to off.

It is noted that the glass-whole-surface utilization flag is set to off at the initial state. Thereafter, the processing for glass moving distance switch setting ends, and the process proceeds to step S150A following step S150 in FIG. 15.

At step S154, whether or not an operation for setting such that glass movement effective length Lg is automatically determined has been performed is determined. Specifically, unit control portion 270 determines whether or not the user has pressed down button image 749 after the user pressed down button image 742. If it is determined as YES at step S154, the process proceeds to step S154A. If it is determined as NO at step S154, the process proceeds to step S156.

At step S154A, setting such that glass movement effective length Lg is automatically determined is made. Specifically, unit control portion 270 sets the glass-whole-surface utilization flag to off.

In the present embodiment, two options, i.e., an option to set glass movement effective length Lg to whole surface of contact glass 210 and an option to set such that glass movement effective length Lg is automatically determined in accordance with a position of a large foreign matter have been described, however, additional options may be provided by preparing a plurality of choices such as ½ or ⅓ of contact glass 210, without limited to such setting as glass movement effective length Lg being set to whole surface of contact glass 210.

Thereafter, the processing for glass moving distance switch setting ends, and the process proceeds to step S150A following step S150 in FIG. 15.

At step S156, whether or not an operation for ending the processing for glass moving distance switch setting has been performed is determined. Specifically, unit control portion 270 determines whether or not the user has pressed down button image 748. If it is determined as YES at step S156, the processing for glass moving distance switch setting ends, and the process proceeds to step S150A following step S150 in FIG. 15. If it is determined as NO at step S156, the process at step S152 is repeated.

Referring again to FIG. 15, after the processing at step S150, the process proceeds to step S150A.

At step S150A, the user choice image is displayed on display portion 310 through the processing similar to that at step S109. In the user choice image, what has been set through the processing for glass moving distance switch setting is displayed. Thereafter, the process proceeds to step S150B.

At step S150B, unit control portion 270 determines whether or not the user has pressed down warning setting button image 635. Warning setting button image 635 is a button image for displaying an image for setting warning timing when the glass moving speed is out of the allowable range.

If it is determined as YES at step S150B, the process proceeds to step S160. If it is determined as NO at step S150B, the process proceeds to S160B which will be described later.

At step S160, processing for setting warning timing is performed.

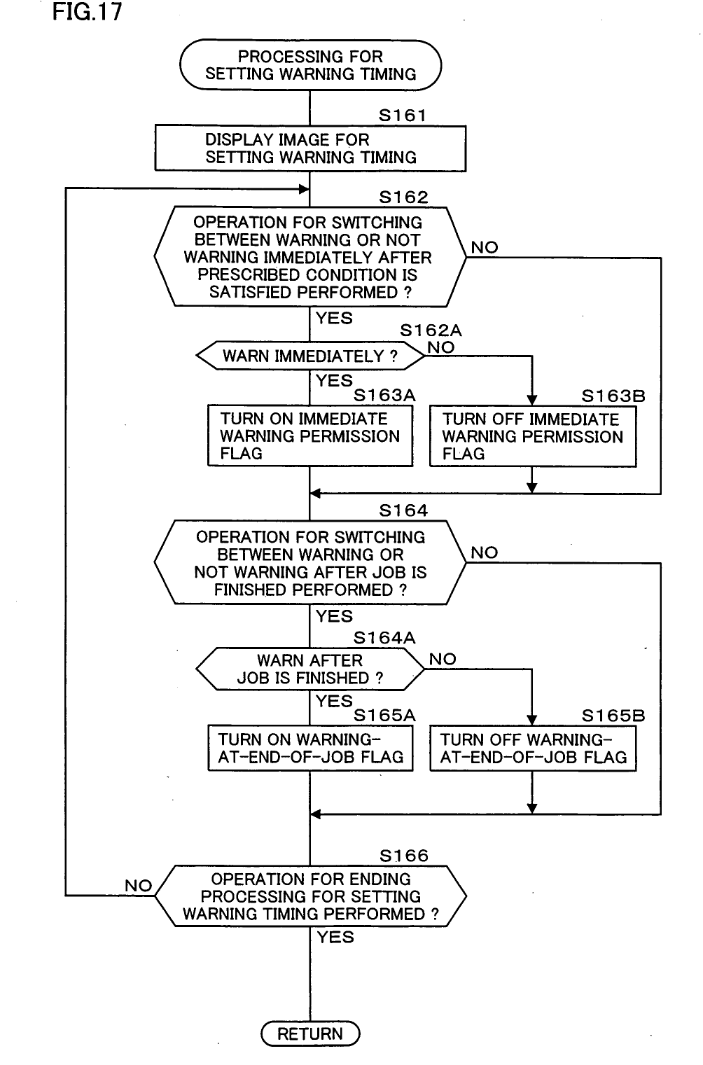

FIG. 17 is a flowchart of the processing for setting warning timing.

Referring to FIG. 17, at step S161, panel control portion 370 causes display portion 310 to display an image for setting warning timing in response to a control instruction from unit control portion 270.

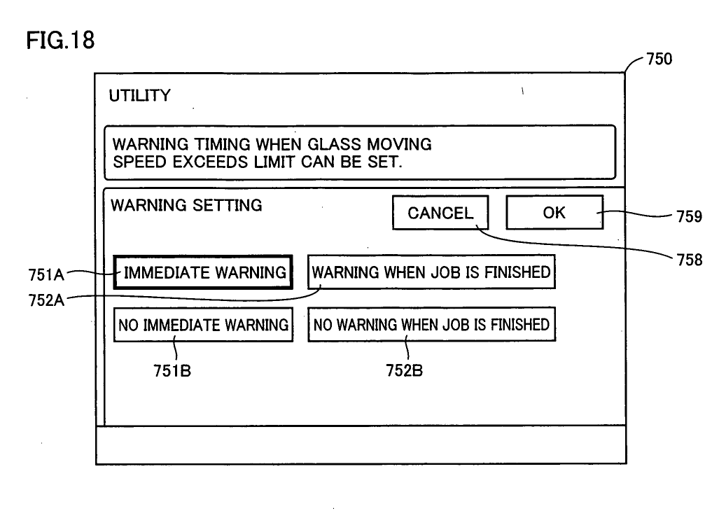

Referring to FIG. 18, in a warning timing setting image 750, button images 751A, 751B, 752A, 752B, 758, and 759 are arranged.

Button image 751A is a button image for setting the timing of warning to immediately after a prescribed condition is satisfied. Button image 751B is a button image for setting the timing of warning to not immediately after a prescribed condition is satisfied.

Button image 752A is a button image for setting the timing of warning to the end of job. Button image 752B is a button image for not setting the timing of warning to the end of job.

Button image 758 is a button image for ending the processing for setting warning timing. Button image 759 is a button image for setting the timing of warning to timing corresponding to button image 751 or button image 752.

Referring again to FIG. 17, after the processing at step S161, the process proceeds to step S162.

At step S162, whether or not an operation for switching between warning and not warning immediately after a prescribed condition is satisfied has been performed is determined. Here, the prescribed condition is such that an area where a detected large foreign matter is present is not smaller than a prescribed area. Specifically, panel control portion 370 determines whether or not the user has pressed down button image 759 after the user pressed down button image 751A or 751B. If it is determined as YES at step S162, the process proceeds to step S162A. If it is determined as NO at step S162, the process proceeds to step S164.

At step S162A, whether or not to warn immediately after a prescribed condition is satisfied is determined. Specifically, panel control portion 370 determines whether or not the user has pressed down button image 759 after the user pressed down button image 751A.

If it is determined as YES at step S162A, the process proceeds to step S163A. If it is determined as NO at step S162A (the user has pressed down button image 759 after the user pressed down button image 751B), the process proceeds to S163B.

At step S163A, panel control portion 370 sets an immediate warning permission flag stored in data temporary storage portion 390 to on. The immediate warning permission flag is a flag for setting the warning timing to immediately after a prescribed condition is satisfied when it is set to on. It is noted that the immediate warning permission flag is set to off at the initial state. Thereafter, the process proceeds to step S164.

At step S163B, panel control portion 370 sets the immediate warning permission flag stored in data temporary storage portion 390 to off. Thereafter, the process proceeds to step S164.

At step S164, whether or not an operation for switching between warning and not warning when a job is finished has been performed is determined. Specifically, panel control portion 370 determines whether or not the user has pressed down button image 759 after the user pressed down button image 752A or 752B. If it is determined as YES at step S164, the process proceeds to step S164A. If it is determined as NO at step S164, the process proceeds to step S166.

At step S164A, whether or not to warn when a job is finished is determined. Specifically, panel control portion 370 determines whether or not the user has pressed down button image 759 after the user pressed down button image 752A.

If it is determined as YES at step S164A, the process proceeds to step S165A. If it is determined as NO at step S164A (the user has pressed down button image 759 after the user pressed down button image 752B), the process proceeds to S165B.

At step S165A, panel control portion 370 sets a warning-at-end-of-JOB flag stored in data temporary storage portion 390 to on. The warning-at-end-of-JOB flag is a flag for setting the warning timing to the end of a job when it is set to on. It is noted that the warning-at-end-of-JOB flag is set to off at the initial state. Thereafter, the process proceeds to step S166.

At step S165B, panel control portion 370 sets the warning-at-end-of-JOB flag stored in data temporary storage portion 390 to off. Thereafter, the process proceeds to step S166.

At step S166, whether or not an operation for ending the processing for setting warning timing has been performed is determined. Specifically, unit control portion 270 determines whether or not the user has pressed down button image 758. If it is determined as YES at step S166, the processing for setting warning timing ends, and the process proceeds to step S160A following step S160 in FIG. 15. If it is determined as NO at step S166, the process at step S162 is repeated.

Through the processing described above, in the present embodiment, both of the immediate warning permission flag and the warning-at-end-of-JOB flag may be turned on. In the present embodiment, however, the processing may be such that only one of the immediate warning permission flag and the warning-at-end-of-JOB flag is set to on. For example, if the warning-at-end-of-JOB flag is on when the immediate warning permission flag is set to on, the warning-at-end-of-JOB flag is set to off.

Referring again to FIG. 15, after the processing at step S160, the process proceeds to step S160A.

At step S160A, the user choice image is displayed on display portion 310 through the processing similar to that at step S109. In the user choice image, what has been set through the processing for setting warning timing is displayed. Thereafter, the process proceeds to step S160B.

At step S160B, whether or not an operation for ending various types of setting has been performed is determined. Specifically, unit control portion 270 determines whether or not the user has pressed down any button image for moving to other screen, such as setting end button image 639.

If it is determined as YES at step S160B, the initial setting processing ends. If it is determined as NO at step S160B, the process at step S110 is performed.

Processing performed by image forming apparatus 1000 (hereinafter, also referred to as image forming processing) in the present embodiment will now be described. The image forming processing is performed for each one JOB (for example, processing for copying 100 documents). The image forming processing is performed in response to an instruction to start JOB by pressing-down of start key 325 by the user. Here, panel control portion 370 causes data temporary storage portion 390 to store information input by the user through operation keys 320. The input information stored in data temporary storage portion 390 is assumed as the information input by the user through operation keys 320, other than in the initial setting processing described previously.

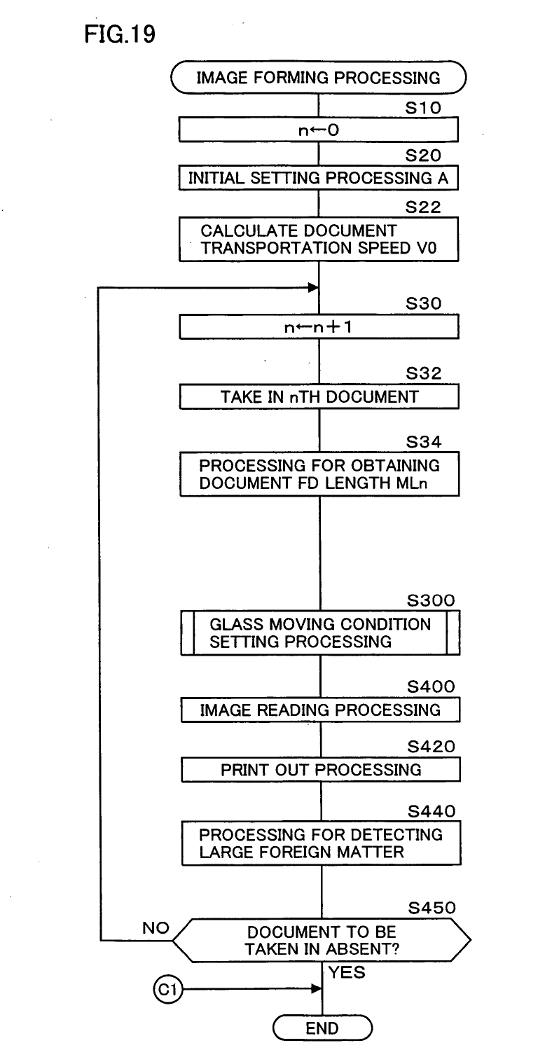

FIG. 19 is a flowchart of the image forming processing.

Referring to FIG. 19, at step S10, unit control portion 270 sets a document number count variable n to “0”. Document number count variable n is a variable for counting the number of documents in one JOB. Document number count variable n is stored in storage portion 290. Thereafter, the process proceeds to step S20.

At step S20, initial setting processing A is performed. In initial setting processing A, unit control portion 270 transmits to panel control portion 370 a control instruction for obtaining information input through the operation to press down operation keys 320 by the user, that has been stored in data temporary storage portion 390. In the following, the information input through the operation to press down operation keys 320 by the user is also referred to as user input information. The user input information includes, for example, copy count, copy density, set magnification rate of the document (copy magnification rate), and the like.

Panel control portion 370 reads the user input information stored in data temporary storage portion 390 based on the received control instruction, and transmits the information to unit control portion 270. Unit control portion 270 causes storage portion 290 to store the received user input information. Thereafter, the process proceeds to step S22.

At step S22, processing for calculating document transportation speed V0 is performed. Initially, unit control portion 270 reads information on the set magnification rate of a document (for example, 120% magnification rate) out of the user input information stored in storage portion 290. In the following, the information on the set magnification rate of the document is also referred to as document set magnification rate information.

Thereafter, unit control portion 270 calculates document transportation speed V0 based on the document set magnification rate information and data on a reading speed of image processing portion 240 stored in storage portion 290. If the document set magnification rate is set to 100%, document transportation speed V0 is identical to the reading speed of image processing portion 240. Unit control portion 270 causes storage portion 290 to store data of calculated document transportation speed V0. In addition, unit control portion 270 transmits to ADF control portion 170 a control instruction to transport the document at document transportation speed V0. ADF control portion 170 makes setting for transporting the document at document transportation speed V0 based on the control instruction. Thereafter, the process proceeds to step S30.

At step S30, unit control portion 270 increments document number count variable n by “1”. Thereafter, the process proceeds to step S32.

At step S32, processing for taking in an nth document is performed. Specifically, unit control portion 270 transmits to ADF control portion 170 a control instruction for taking in the nth document among a plurality of documents included in document group 115. ADF control portion 170 transmits a control instruction for taking in the nth document to motor drive control portion 175. Motor drive control portion 175 operates paper feed roller 120A in response to the received control instruction, to start take-in of the nth document. Thereafter, the process proceeds to step S34.

At step S34, processing for obtaining a document FD length MLn is performed. In the processing for obtaining document FD length MLn, ADF control portion 170 determines (obtains) document FD length MLn of the nth document, based on duration of time in which a signal indicating that the document is passing is continuously received from document passage sensor 119 based on the taken-in nth document. The nth document that has started to be taken in at step S32 once stops at pre-reading roller 120C. After the image reading processing for an n−1th document is finished, the nth document is transported so as to pass document reading position L1 as a result of operation of pre-reading roller 120C. Then, ADF control portion 170 causes data temporary storage portion 190 to store data of document FD length MLn.

The processing for obtaining document FD length MLn is repeated for each document being taken in. It is noted that a document FD length obtained through preceding processing for obtaining document FD length MLn is expressed as ML(n−1).

The processing at step S34 is repeated for each document being taken in. Therefore, if document FD length MLn has already been stored in data temporary storage portion 190, ADF control portion 170 causes newly obtained document FD length MLn to be stored, with one piece of data of old document FD length ML(n−1) being left. In other words, data temporary storage portion 190 stores two pieces of data of document FD lengths.

If data temporary storage portion 190 has already stored two pieces of data of document FD lengths, ADF control portion 170 overwrites the old data of document FD length with the newly obtained data of document FD length MLn for storage.

Thereafter, unit control portion 270 determines whether or not latest document FD length MLn is different from document FD length ML(n−1) obtained through the preceding processing for obtaining document FD length MLn. Unit control portion 270 transmits a control instruction for obtaining document FD length MLn and document FD length ML(n−1) to ADF control portion 170, so as to obtain document FD length MLn and document FD length ML(n−1).

Thereafter, unit control portion 270 determines whether or not latest document FD length MLn is different from document FD length ML(n−1) obtained through the preceding processing for obtaining document FD length MLn. If latest document FD length MLn is different from document FD length ML(n−1), unit control portion 270 sets a document length change flag stored in storage portion 290 to on. The document length change flag is a flag indicating that document FD length MLn is different from document FD length ML(n−1) if it is set to on. It is noted that the document length change flag is set to off at the initial state.

The fact that document FD length MLn is different from document FD length ML(n−1) indicates that a plurality of documents of different sizes are included in document group 115.

On the other hand, if document FD length MLn is the same as document FD length ML(n−1), unit control portion 270 sets the document length change flag stored in storage portion 290 to off. Thereafter, the process proceeds to step S300.

At step S300, glass moving condition setting processing characterizing the present invention is performed. The glass moving condition setting processing represents processing for setting a moving condition of contact glass 210. The glass moving condition setting processing will be described in detail later. When the glass moving condition setting processing ends, the process proceeds to step S400.

At step S400, the image reading processing described previously is performed. The image reading processing will be described in detail later. When the image reading processing ends, the process proceeds to step S420.

At step S420, print out processing for printing out image data obtained through the image reading processing is performed. The print out processing will be described in detail later. When the print out processing ends, the process proceeds to step S440.

At step S440, the processing for detecting a large foreign matter described previously is performed. The processing for detecting a large foreign matter is repeated for each document being taken in. In addition, the processing for detecting a large foreign matter is performed also when image forming apparatus 1000 is turned on. In order to avoid unnecessary change in the glass moving speed depending on frequency of adhesion of dust to contact glass 210, the processing for detecting a large foreign matter may be performed once in prescribed times of the image reading processing.

In the processing for detecting a large foreign matter, as described previously, unit control portion 270 calculates a position of the large foreign matter on contact glass 210, and causes storage portion 290 to store the data on the position of the large foreign matter. In the processing for detecting a large foreign matter, a plurality of large foreign matters may be detected.

In the following, the data on the position of the large foreign matter calculated through the preceding processing for detecting a large foreign matter is also referred to as old large foreign matter position data. In addition, the data on the position of the large foreign matter calculated through the present processing for detecting a large foreign matter is also referred to as new large foreign matter position data. If a plurality of large foreign matters are detected through the processing for detecting a large foreign matter, the large foreign matter position data includes a plurality of pieces of position data corresponding to the plurality of large foreign matters respectively.

The processing at step S440 is repeated for each document being taken in. Therefore, if old large foreign matter position data has already been stored in storage portion 290, unit control portion 270 causes newly calculated new large foreign matter position data to be stored, with one piece of data of old large foreign matter position data being left. In other words, storage portion 290 stores two pieces of data of large foreign matter positions.

If storage portion 290 has already stored two pieces of data of large foreign matter positions, unit control portion 270 overwrites the old large foreign matter position data with the newly calculated large foreign matter position data for storage.

In addition, if storage portion 290 has already stored two pieces of data of large foreign matter positions, unit control portion 270 performs the following data comparison processing.

In the data comparison processing, unit control portion 270 determines whether or not the old large foreign matter position data is the same as the new large foreign matter position data. If the old large foreign matter position data is not the same as the new large foreign matter position data, unit control portion 270 sets a foreign matter position change flag stored in storage portion 290 to on. If the old large foreign matter position data is the same as the new large foreign matter position data, unit control portion 270 sets the foreign matter position change flag stored in storage portion 290 to off. The foreign matter position change flag is a flag indicating that the large foreign matter position data has been changed. Thereafter, the process proceeds to step S450.

At step S450, whether a document to be taken in is present or not is determined. Specifically, unit control portion 270 transmits to ADF control portion 170 a control instruction for confirming whether or not a document set on paper feed tray 110 is present. In the following, information indicating whether or not a document set on paper feed tray 110 is present is also referred to as document presence information. ADF control portion 170 determines a signal from document size detection sensor 118 based on the received control instruction, to obtain the document presence information and transmit the same to unit control portion 270. Through the processing above, unit control portion 270 determines whether or not a document set on paper feed tray 110 is present.

If it is determined as YES at step S450, the image forming processing ends. When the image forming processing ends, unit control portion 270 transmits a notification signal for notification of the end of JOB to panel control portion 370. Panel control portion 370 changes an image displayed on display portion 310 based on the received notification signal. If it is determined as NO at step S450, the processing at step S30 is repeated.

The glass moving condition setting processing performed at step S300 in the image forming processing will now be described in detail.

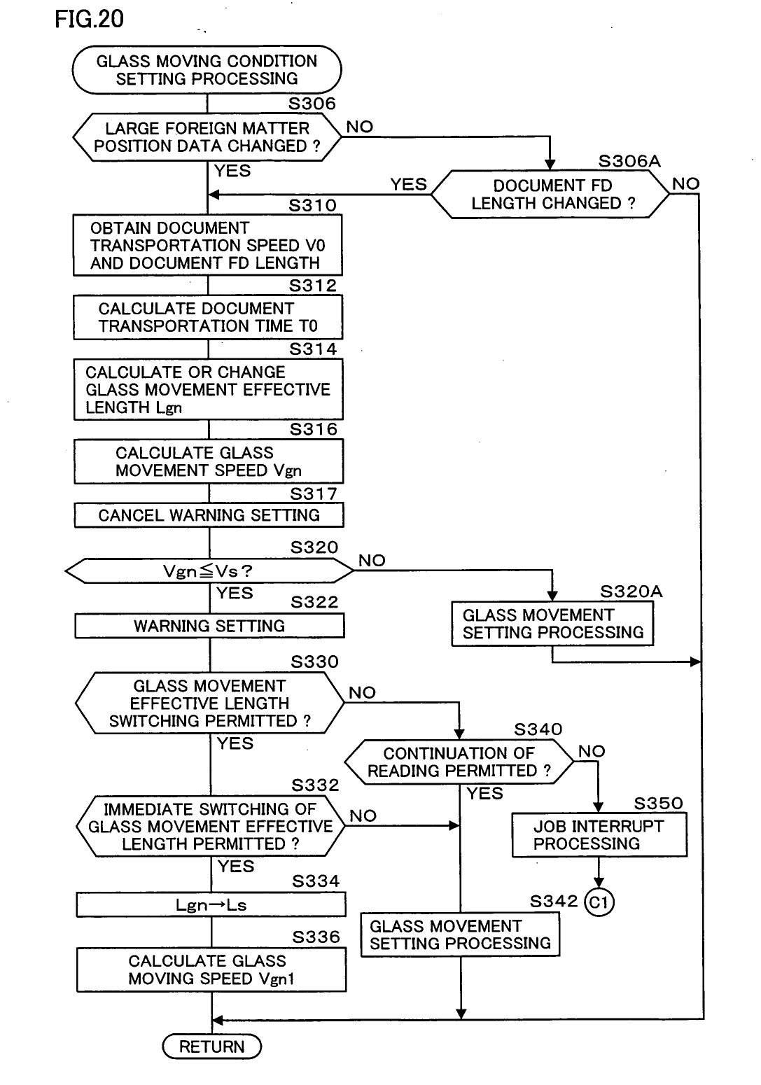

FIG. 20 is a flowchart of the glass moving condition setting processing.

Referring to FIG. 20, at step S306, whether or not the large foreign matter position data has been changed is determined. Specifically, unit control portion 270 determines whether or not the foreign matter position change flag stored in storage portion 290 is turned on.

If it is determined as YES at step S306, the process proceeds to step S310. If it is determined as NO at step S306, the process proceeds to S306A.

At step S306A, whether or not the document FD length has been changed is determined. Specifically, unit control portion 270 determines whether or not the document length change flag stored in storage portion 290 described previously is turned on.

If it is determined as YES at step S306A, the process proceeds to step S310. If it is determined as NO at step S306A, the glass moving condition setting processing ends, and the process returns to the image forming processing in FIG. 19 and proceeds to step S400 following step S300. In this manner, the image reading processing is performed, with current setting of the glass moving speed, the document transportation speed and the document set magnification rate being maintained.

At step S310, document transportation speed V0 and the document FD length are obtained. Specifically, unit control portion 270 reads data on document transportation speed V0 from storage portion 290. In addition, unit control portion 270 transmits a control instruction for obtaining document FD length MLn to ADF control portion 170. ADF control portion 170 transmits the data on document FD length MLn to unit control portion 270, based on the received control instruction. Through the processing above, unit control portion 270 obtains document FD length MLn. Thereafter, the process proceeds to step S312.

At step S312, initial document transportation time T0 is calculated. Specifically, unit control portion 270 calculates document transportation time T0 based on Equation (5) below.
T0=MLn/V0 (5)
Thereafter, the process proceeds to step S314.

At step S314, glass movement effective length Lgn is calculated or changed. If the processing at step S314 described below is performed for the first time, glass movement effective length Lgn is calculated. Otherwise, glass movement effective length Lgn is changed.

In the following, description on processing will be provided. Unit control portion 270 determines whether or not the glass-whole-surface utilization flag stored in storage portion 290 is turned on. If the glass-whole-surface utilization flag is turned on, unit control portion 270 sets glass movement effective length Lgn to whole surface of contact glass 210.

If the glass-whole-surface utilization flag is turned off, unit control portion 270 automatically calculates glass movement effective length Lgn based on the latest large foreign matter position data stored in storage portion 290. Specific processing for automatically calculating glass movement effective length Lgn (hereinafter, also referred to as glass movement effective length automatic calculation processing) will now be described.

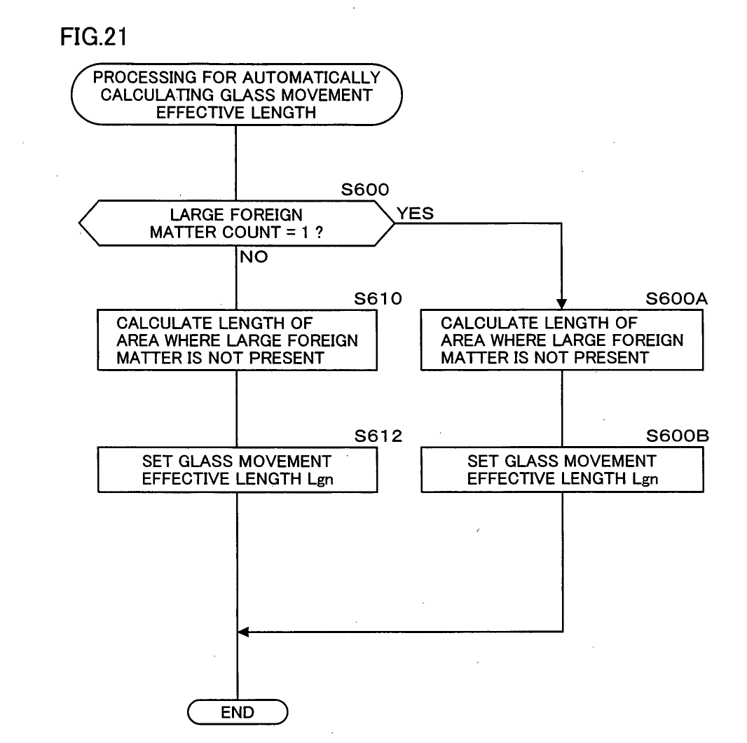

FIG. 21 is a flowchart of the processing for automatically calculating the glass movement effective length.

Referring to FIG. 21, at step S600, whether or not there is “one” large foreign matter on contact glass 210 is determined. Specifically, unit control portion 270 determines whether or not the latest large foreign matter position data includes one piece of position data, instead of a plurality of pieces of position data corresponding to a plurality of large foreign matters respectively.

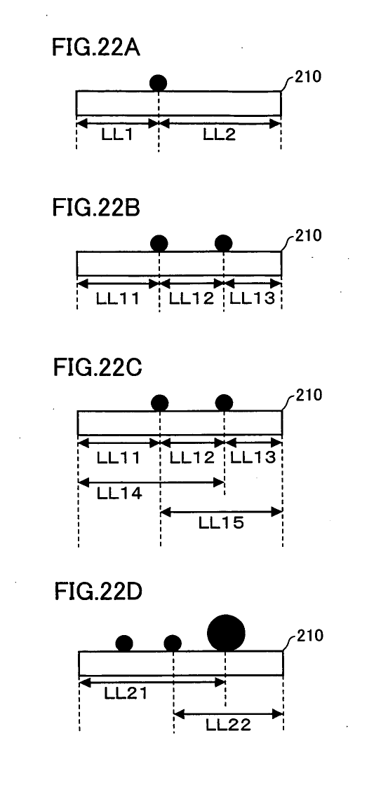

FIG. 22(A) shows a state where one large foreign matter is present on contact glass 210.

Referring again to FIG. 21, if it is determined as YES at step S600 (see FIG. 22(A)), the process proceeds to step S600A. If it is determined as NO at step S600, the process proceeds to step S610.

At step S600A, a length of an area where a large foreign matter is not present is calculated. Here, a position of the large foreign matter is assumed, for example, as a position shown in FIG. 22(A). Then, a length of an area LL1 from the position where one large foreign matter is present to one end of contact glass 210 and a length of an area LL2 from the position where one large foreign matter is present to the other end of contact glass 210 are calculated.

Specifically, unit control portion 270 calculates the length of area LL1 and area LL2 based on the data on the length of contact glass 210 and the large foreign matter position data. The data on the length of contact glass 210 is stored in advance in storage portion 290. Thereafter, the process proceeds to step S600B.

At step S600B, unit control portion 270 sets a larger value out of calculated lengths of area LL1 and area LL2 (length of area LL2) as glass movement effective length Lgn. Then, unit control portion 270 makes setting for using area LL2 in contact glass 210 during the image reading processing. Thereafter, the processing for automatically calculating the glass movement effective length ends.

In the following, it is assumed that unit control portion 270 sets an area, of which length has been set as glass movement effective length Lgn, also as an area in contact glass 210 used during the image reading processing (hereinafter, also referred to as a glass moving area).

Referring again to FIG. 22, FIG. 22(B) shows a state where a plurality of large foreign matters are present on contact glass 210. FIG. 22(B) exemplarily shows a state where two large foreign matters are present.

Referring again to FIG. 21, if it is determined as NO at step S600 described previously (the latest large foreign matter position data includes a plurality of pieces of position data corresponding to the plurality of large foreign matters respectively), the process proceeds to step S610.

At step S610, a length of the area where a large foreign matter is not present is calculated. Here, positions of the large foreign matters are assumed, for example, as positions shown in FIG. 22(B). Then, lengths of an area LL11, an area LL12 and an area LL13 are calculated. Specifically, unit control portion 270 calculates the lengths of area LL11, area LL12 and area LL13 based on the data on the length of contact glass 210 and the large foreign matter position data. Thereafter, the process proceeds to step S612.

At step S612, unit control portion 270 sets the largest value out of the calculated lengths of area LL11, area LL12 and area LL13 (length of area LL11) as glass movement effective length Lgn.

Thereafter, the processing for automatically calculating the glass movement effective length ends. Through the processing for automatically calculating the glass movement effective length, glass movement effective length Lgn is calculated and an area of contact glass 210 to be used during the image reading processing is also set.

It is noted that the method of calculating glass movement effective length Lgn described in the processing for automatically calculating the glass movement effective length in FIG. 21 is by way of example, and glass movement effective length Lgn may be calculated with other calculation method.

For example, a state where a plurality of large foreign matters are present on contact glass 210 as shown in FIG. 22(C) is assumed.

Here, according to one example of other calculation method, it is assumed that the length of area LL11 largest among the lengths of area LL11, area LL12 and area LL13, where a large foreign matter is not present, is set as glass movement effective length Lgn. Then, it is assumed that, using glass movement effective length Lgn, glass moving speed Vgn calculated at step S316 which will be described later attains to a speed not higher than allowable speed Vs set in the processing described previously.

Here, a length of an area including the smallest foreign matter out of the plurality of areas each including one large foreign matter (an area LL14 and an area LL15) is set as glass movement effective length Lgn.

According to another calculation method, among a plurality of areas including different numbers of large foreign matters, i.e., 1, 2, 3, and 4, respectively, a length of an area where the total area of large foreign matters included therein is smallest is set as glass movement effective length Lgn.

Most preferably, glass movement effective length Lgn is set to a length of an area affecting, due to a large foreign matter, least to an image during the image reading processing, corresponding to glass movement effective length Lgn, in which glass moving speed Vgn calculated at step S316 which will be described later is larger than allowable speed Vs with the use of glass movement effective length Lgn.

For example, as shown in FIG. 22(D), an area LL22 including an extremely large foreign matter and an area LL21 including two large foreign matters are assumed. Here, if the area of the large foreign matter included in area LL22 is larger than the total of the areas of two large foreign matters included in area LL21, the length of area LL21 is set as glass movement effective length Lgn so as to suppress influence on the image during the image reading processing.

Unit control portion 270 causes storage portion 290 to store calculated glass movement effective length Lgn and the corresponding glass moving area in association with each other. If glass movement effective length Lgn has already been stored in storage portion 290 through the processing at preceding step S314, unit control portion 270 causes newly calculated glass movement effective length Lgn to be stored, with one piece of data of old glass movement effective length Lg(n−1) being left. In other words, storage portion 290 stores two pieces of data of glass movement effective lengths.

If storage portion 290 has already stored two pieces of data of glass movement effective lengths, unit control portion 270 overwrites the data of the old glass movement effective length with the data of glass movement effective length Lgn for storage. Thereafter, the process proceeds to step S316.

At step S316, glass moving speed Vgn is calculated. Specifically, unit control portion 270 calculates glass moving speed Vgn based on Equation (6) below.
Vgn=Lgn/T0 (6)
Unit control portion 270 causes storage portion 290 to store calculated glass moving speed Vgn. If glass moving speed Vg(n−1) has already been stored in storage portion 290 through the processing at preceding step S316, unit control portion 270 causes newly calculated glass moving speed Vgn to be stored, with one piece of data of old glass moving speed Vg(n−1) being left. In other words, storage portion 290 stores two pieces of data of glass moving speeds.

If storage portion 290 has already stored two pieces of data of glass moving speeds, unit control portion 270 overwrites the data of the old glass moving speed with glass moving speed Vgn for storage. Thereafter, the process proceeds to step S317.

At step S317, setting for displaying a warning message on display portion 310 is cancelled. Specifically, unit control portion 270 transmits to panel control portion 370 a control instruction to turn off a warning flag provided in data temporary storage portion 390. Through this processing, panel control portion 370 turns off the warning flag provided in data temporary storage portion 390. The warning flag is a flag for determining whether or not to display a warning message on display portion 310. Thereafter, the process proceeds to step S320.

At step S320, unit control portion 270 determines whether glass moving speed Vgn calculated at step S316 is not larger than allowable speed Vs set at the processing described previously. If it is determined as YES at step S320, the process proceeds to step S322. If it is determined as NO at step S320, the process proceeds to S320A.

At step S320A, unit control portion 270 sets the moving speed of contact glass 210 to glass moving speed Vgn. With this setting, movement of contact glass 210 is controlled to attain glass moving speed Vgn.

In addition, unit control portion 270 sets the glass movement effective length of contact glass 210 to glass movement effective length Lgn stored in storage portion 290 and sets an area used during the image reading processing to the glass moving area associated with glass movement effective length Lgn. With this setting, contact glass 210 is controlled to move by a distance of glass movement effective length Lgn, using the set glass moving area. Thereafter, the glass moving condition setting processing ends, and the process returns to the image forming processing in FIG. 19 and proceeds to step S400 following step S300.

At step S322, setting for displaying a warning message on display portion 310 is made. Specifically, unit control portion 270 transmits to panel control portion 370 a control instruction to turn on the warning flag provided in data temporary storage portion 390. Through this processing, panel control portion 370 turns on the warning flag provided in data temporary storage portion 390. Thereafter, the process proceeds to step S330.

If movement of contact glass 210 is controlled to attain glass moving speed Vgn satisfying the condition at step S320, the problem as described above occurs. Therefore, in order to solve such a problem, processing at step S330 or later is performed.

At step S330, whether or not switching of the glass movement effective length is permitted is determined. Specifically, unit control portion 270 determines whether or not the glass movement effective length switch permission flag stored in storage portion 290 described previously is turned on.

If it is determined as YES at step S330, the process proceeds to step S332. If it is determined as NO at step S330, the process proceeds to S340.

At step S340, whether or not continuation of document reading is permitted is determined. Specifically, unit control portion 270 determines whether or not the document reading continuation permission flag stored in storage portion 290 described previously is turned on. One example where the processing at step S340 is performed is such that the user desires reading of a plurality of documents with the same quality even if there is stripe noise or the like. If it is determined as YES at step S340, the process proceeds to step S342. If it is determined as NO at step S340, the process proceeds to S350.

At step S342, glass movement setting processing is performed. In the glass movement setting processing, unit control portion 270 makes setting such that the moving speed of contact glass 210 is set to glass moving speed Vg(n−1) stored in storage portion 290. It is assumed here that glass moving speed Vg(n−1) is not slower than allowable speed Vs. With this setting, movement of contact glass 210 is controlled to attain glass moving speed Vg(n−1) not slower than allowable speed Vs, instead of glass moving speed Vgn determined as higher than allowable speed Vs.

In addition, unit control portion 270 makes setting such that the glass movement effective length of contact glass 210 is set to glass movement effective length Lg(n−1) stored in storage portion 290. It is assumed here that glass movement effective length Lg(n−1) is not smaller than prescribed value Ls described previously. With this setting, contact glass 210 is controlled to move by a distance of glass movement effective length Lg(n−1) not smaller than prescribed value Ls. Here, a large foreign matter newly detected in the processing at preceding step S440 is subjected to noise removal to a degree possible in the noise removal processing alone.

Thereafter, the glass moving condition setting processing ends, and the process returns to the image forming processing in FIG. 19 and proceeds to step S400 following step S300.

At step S350, JOB interrupt processing is performed. In the JOB interrupt processing, processing for interrupting JOB being processed is performed. Specifically, unit control portion 270 issues to ADF control portion 170 within ADF 100, a control instruction for stopping processing for feeding a new document and a control instruction for outputting a document that has been fed.

Then, unit control portion 270 transmits a control instruction to turn on a JOB interruption warning flag provided in data temporary storage portion 390 to panel control portion 370. Through this processing, panel control portion 370 turns on the JOB interruption warning flag provided in data temporary storage portion 390. The JOB interruption warning flag is a flag for displaying a warning message on display portion 310 after the JOB is interrupted. It is noted that the JOB interruption warning flag is set to off at the initial state. Thereafter, the glass moving condition setting processing ends, and the process returns to the image forming processing in FIG. 19 and the image forming processing also ends.

At step S332, whether or not immediate switching of the glass movement effective length is permitted if glass moving speed Vgn is not higher than allowable speed Vs is determined. The determination processing is based on data on timing of switching the glass movement effective length set by the user in advance through operation keys 320, other than in the initial setting processing described previously (hereinafter, also referred to as timing data).

The timing data indicates whether or not immediate switching of the glass movement effective length is permitted if glass moving speed Vgn is not higher than allowable speed Vs. In other words, the user sets whether to permit immediate switching of the glass movement effective length if glass moving speed Vgn is not higher than allowable speed Vs prior to the image forming processing.

The timing data is stored in storage portion 290. Unit control portion 270 determines whether or not immediate switching of the glass movement effective length is permitted, based on the timing data stored in storage portion 290. If it is determined as YES at step S332, the process proceeds to step S334. If it is determined as NO at step S332, the process proceeds to S342 described previously.

At step S334, unit control portion 270 changes glass movement effective length Lgn to prescribed value Ls described previously. In other words, the used area in contact glass 210 is changed to an area adapted to prescribed value Ls set in advance (see, for example, FIG. 4(D)). It is noted that the area adapted to prescribed value Ls is not limited to the area from the left end of contact glass 210 to a position distant to the right by prescribed value Ls. A portion adapted to prescribed value Ls is various, depending on a place of the glass moving area that has been set.

If glass movement effective length Lgn is set to a length of area LL13 shown in FIG. 22(B), for example, the area adapted to prescribed value Ls is an area from the right end of contact glass 210 to a position distant to the left by prescribed value Ls. Thereafter, the process proceeds to step S336.

At step S336, unit control portion 270 calculates glass moving speed Vgn1 by substituting into Equation (7) below, glass movement effective length Ls that has been obtained or calculated in the processing described previously and document transportation time T0.
Vgn1=Ls/T0 (7)
It is noted that calculated glass moving speed Vgn1 is not slower than allowable speed Vs. Unit control portion 270 sets the moving speed of contact glass 210 to glass moving speed Vgn1.

With this setting, movement of contact glass 210 is controlled to attain glass moving speed Vgn1. Thereafter, the glass moving condition setting processing ends, and the process returns to the image forming processing in FIG. 19 and proceeds to step S400 following step S300.

At step S400, the image reading processing is performed. In the image reading processing, ADF control portion 170 transmits to motor drive control portion 175 a control instruction for transporting the nth document at document transportation speed V0 set in the processing at step S22. Motor drive control portion 175 controls pre-reading roller 120C such that the nth document passes document reading position L1 at a designated document transportation speed, based on the received control instruction.

In synchronization with passage of document reading position L1 of the nth document, unit control portion 270 controls contact glass 210, such that the glass attains the glass moving speed and moves by a distance of the glass movement effective length set in the glass moving condition setting processing.

The glass moving speed and the glass movement effective length are set, for example, to glass moving speed Vgn1 and glass movement effective length Ls, respectively.

Unit control portion 270 sends a control instruction for movement control to motor drive control portion 275A. Motor drive control portion 275A operates drive pulse motor 250A so as to control movement of contact glass 210, based on the received control instruction.

In addition, during a period from start to end of passage of document reading position L1 of the nth document, image processing portion 240 performs the processing described in connection with FIG. 3, in which the nth document is read as image data and stored in storage portion 290.

As described above, in movement control of contact glass 210, if a large foreign matter is present on contact glass 210 adapted to glass movement effective length Ls, stripe noise is generated. Movement of contact glass 210, however, is controlled to attain glass moving speed Vgn1 not slower than allowable speed Vs. Therefore, image processing portion 240 can read a plurality of documents with the same quality, and the noise removal performance in the noise removal processing for removing noise due to a foreign matter smaller than the large foreign matter can be maintained at a level not lower than a prescribed level. Therefore, a high-quality image with low noise can effectively be obtained.

In addition, movement of contact glass 210 is controlled to attain glass moving speed Vgn1 not slower than allowable speed Vs. Consequently, vibration sound generated when movement of contact glass 210 is controlled to attain a glass moving speed further slower than allowable speed Vs can effectively be prevented.

Thereafter, the process proceeds to step S420.

At step S420, the print out processing is performed. In the print out processing, unit control portion 270 transmits a control instruction for the print processing and image data stored in storage portion 290 in the processing at step S400 to image forming portion 400.

Image forming portion 400 prints an image in accordance with the received image data on paper, upon receiving the control instruction.

Through the processing above, the image data received by image forming portion 400 results in a high-quality image including low noise. Therefore, the image printed on the paper can be an image of high-quality including low noise.

The warning processing performed when a foreign matter or the like on contact glass 210 is detected will now be described. The warning processing is started, on the premise that the image forming processing described previously has been started. In addition, the warning processing is performed concurrently with the image forming processing within operation panel unit 300. It is noted that a condition for starting the warning processing is not limited to the condition that the image forming processing has been started as described previously.

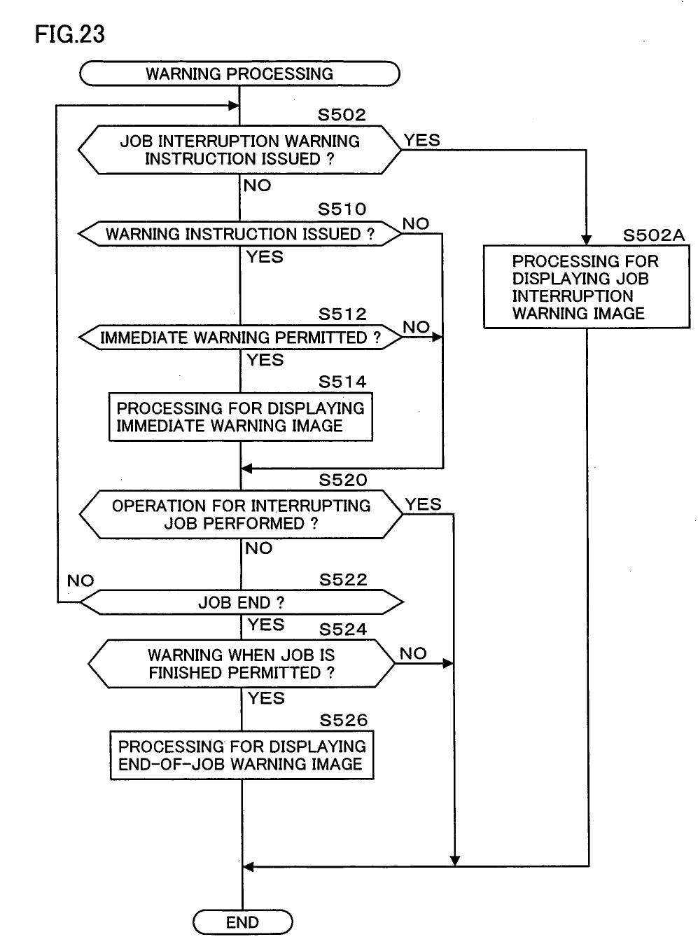

FIG. 23 is a flowchart of the warning processing.

Referring to FIG. 23, at step S502, whether or not a warning instruction at the time of JOB interruption has been issued is determined. Specifically, panel control portion 370 determines whether or not the JOB interruption warning flag provided in data temporary storage portion 390 has been turned on. If it is determined as YES at step S502, the process proceeds to step S502A. If it is determined as NO at step S502, the process proceeds to S510.

At step S502A, processing for displaying a JOB interruption warning image is performed. In the processing for displaying a JOB interruption warning image, panel control portion 370 causes display portion 310 to display the JOB interruption warning image.

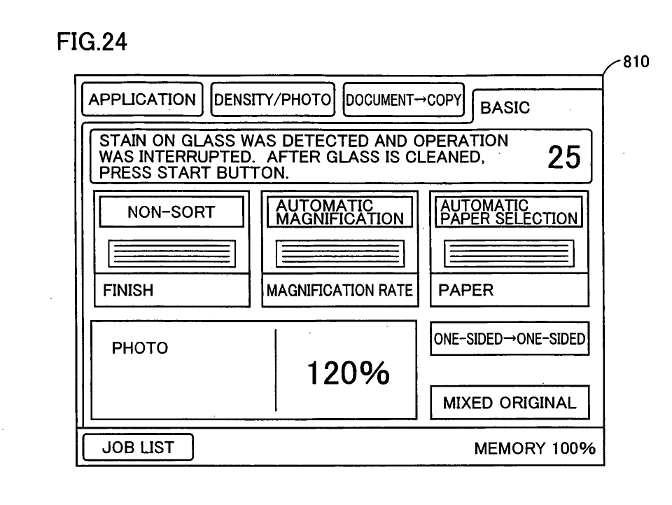

FIG. 24 shows an exemplary JOB interruption warning image 810.

Referring to FIG. 24, JOB interruption warning image 810 is an image displayed on display portion 310 when the JOB interruption processing is performed at step S350. In JOB interruption warning image 810, a message indicating interruption of JOB due to detection of stain on the glass and a message urging the user to clean the glass are displayed.

Referring again to FIG. 23, after the processing at step S502A, the warning processing ends.

At step S510, whether or not the warning instruction has been issued is determined. Specifically, panel control portion 370 determines whether or not the warning flag provided in data temporary storage portion 390 has been turned on. If it is determined as YES at step S510, the process proceeds to step S512. If it is determined as NO at step S510, the process proceeds to S520.

At step S512, whether or not immediate warning is permitted is determined. Specifically, panel control portion 370 determines whether or not the immediate warning permission flag provided in data temporary storage portion 390 has been turned on. If it is determined as YES at step S512, the process proceeds to step S514. If it is determined as NO at step S512, the process proceeds to S520.

At step S514, processing for displaying an immediate warning image is performed. In the processing for displaying an immediate warning image, panel control portion 370 causes display portion 310 to display the immediate warning image.

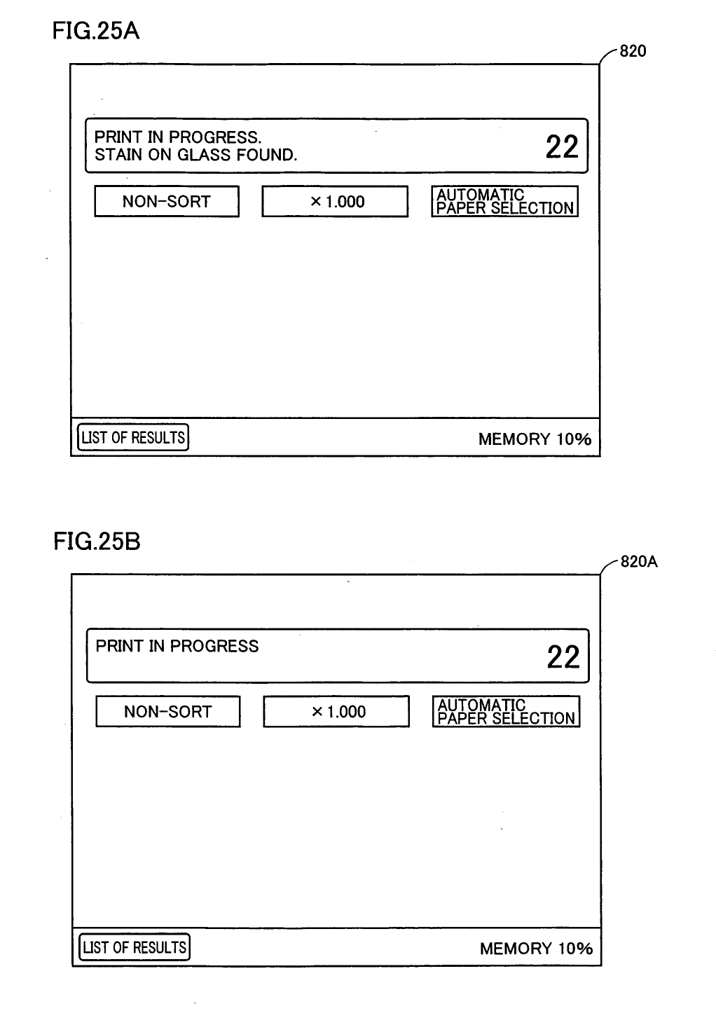

FIG. 25(A) shows an exemplary immediate warning image 820. Immediate warning image 820 is displayed on display portion 310 immediately after stain on contact glass 210 is detected during JOB. In immediate warning image 820, a message indicating printing in progress and a message warning the user of stain on the glass are displayed.

Therefore, the user can immediately know presence of stain on contact glass 210 even during JOB. Consequently, if the user performs the operation to interrupt JOB at a time point when the user notices immediate warning image 820 and knows presence of stain on contact glass 210, unnecessary processing such as low-quality image reading processing or low-quality copy processing can effectively be minimized.

In other words, unnecessary trouble of the user who desires high-quality image reading processing can effectively be minimized. An example of the unnecessary trouble is that the user cleans contact glass 210 after the image reading processing is completed and thereafter performs the image reading processing again.

Referring again to FIG. 23, after the immediate warning image is displayed on display portion 310 and after a prescribed condition is satisfied, panel control portion 370 changes the image displayed on display portion 310 from immediate warning image 820 to an image indicating JOB in progress. An example of the prescribed condition is that a prescribed time (for example, 10 seconds) has elapsed since immediate warning image 820 was displayed on display portion 310. In addition, another example of the prescribed condition is that the user touches some position on display portion 310 while immediate warning image 820 is displayed on display portion 310.

Referring again to FIG. 25, FIG. 25(B) shows an exemplary JOB-in-progress image 820A.

Referring again to FIG. 23, after the processing at step S514, the process proceeds to step S520.

At step S520, whether or not an operation to stop JOB has been performed is determined. Specifically, panel control portion 370 determines whether or not the user has pressed down stop key 326. If it is determined as YES at step S520, the warning processing ends. If it is determined as NO at step S520, the process proceeds to step S522.

At step S522, whether or not JOB has ended is determined. Specifically, panel control portion 370 determines whether or not a notification signal for notification of end of JOB is received from unit control portion 270. If it is determined as YES at step S522, the process proceeds to step S524. If it is determined as NO at step S522, the process at step S502 is repeated.

At step S524, whether or not warning is permitted at the end of JOB is determined. Specifically, panel control portion 370 determines whether or not an end-of-JOB warning flag provided in data temporary storage portion 390 has been turned on. If it is determined as YES at step S524, the process proceeds to step S526. If it is determined as NO at step S524, the warning processing ends.

At step S526, processing for displaying an end-of-job warning image is performed. In the processing for displaying an end-of-job warning image, panel control portion 370 causes display portion 310 to display the end-of-job warning image. The end-of-job warning image is displayed on display portion 310 when JOB ends.

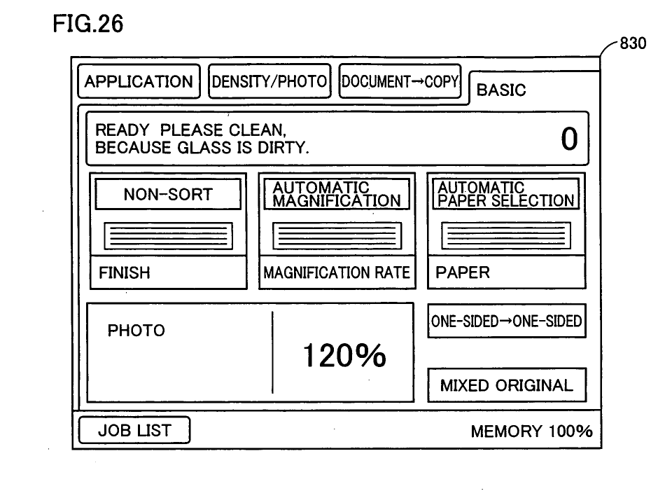

FIG. 26 shows an exemplary end-of-job warning image 830. In the end-of-job warning image, a message that stain on contact glass 210 has been detected during JOB (the image forming processing) and stain is present on the glass and a message urging the user to clean the glass are displayed.

Referring again to FIG. 23, when the processing at step S526 ends, the warning processing ends. If the warning processing is performed during JOB, during a period in which immediate warning image 820 is not displayed on display portion 310, JOB-in-progress image 820A is displayed. In addition, when display portion 310 displays none of immediate warning image 820 and end-of-job warning image 830 during the warning processing, display portion 310 displays, for example, initial image 600 after JOB ends.

Through the processing above, the user who desires high-quality image reading processing cleans contact glass 210 in response to the warning image displayed on display portion 310, so that low-quality image reading processing or low-quality copy processing can effectively be minimized.

In other words, unnecessary trouble of the user who desires high-quality image reading processing can effectively be minimized.

In the present embodiment, an example in which ADF control portion 170 within ADF 100 exerts document transportation control and unit control portion 270 within image reading unit 200 controls movement of contact glass 210 has been described. A single control portion, however, may be responsible for control of document transportation and movement of contact glass 210. For example, the single control portion may be provided in any of ADF 100 and image reading unit 200. That is, any number and any configuration of the control portion may be set.

In addition, in the warning processing, the image displayed on display portion 310 and the message in the image are not limited to those in the present embodiment. Moreover, a method of warning the user is not limited to that in the present embodiment, and other warning means such as an LED may be used for warning instead of displaying an image on display portion 310.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image forming apparatus, comprising:
a document transportation portion for transporting a document in a prescribed direction;
a light exposure portion exposing said document to light;
a transparent member having a transparent portion allowing passage of the light reflected from said document;
a drive portion for moving said transparent member in a direction opposite to said prescribed direction when the document is read;
a document reading portion for reading the light reflected from said document;
an image forming portion forming an image on a prescribed target based on information read by said document reading portion;
a first portion setting portion setting a first transmission portion included in said transparent portion in said transparent member as a transmission area used for allowing passage of said reflected light when said document is read;
a speed setting portion for setting a moving speed of said transparent member based on said first transmission portion;
a moving speed determination portion for determining whether the set moving speed of the transparent member is equal to or smaller than a prescribed moving speed; and
a change portion for changing said transmission area from said first transmission portion to a second transmission portion that has been set in advance when said moving speed determination portion determines that the moving speed of said transparent member is equal to or smaller than said prescribed moving speed; wherein
said speed setting portion sets said moving speed of said transparent member to a moving speed based on said second transmission portion when said change portion changes said transmission area from said first transmission portion to said second transmission portion.

2. The image forming apparatus according to claim 1, further comprising a foreign matter detection portion detecting whether a foreign matter is present on said transparent member, wherein
said first portion setting portion sets said first transmission portion based on a portion where a foreign matter having a size equal to or larger than a prescribed size is absent, out of the transparent portion of said transparent member.

3. The image forming apparatus according to claim 1, further comprising an instruction setting portion for setting a setting instruction as to whether said change portion permits change from said first transmission portion to said second transmission portion, wherein
said change portion changes the transmission area from said first transmission portion to said second transmission portion in accordance with said setting instruction.

4. The image forming apparatus according to claim 1, further comprising a notification portion for notifying a user of prescribed information when said moving speed determination portion determines that the moving speed of said transparent member is equal to or smaller than said prescribed moving speed.

5. The image forming apparatus according to claim 4, further comprising a foreign matter detection portion detecting whether a foreign matter is present on said transparent member, wherein
said prescribed information is information based on the foreign matter detected by said foreign matter detection portion.

6. The image forming apparatus according to claim 4, further comprising a reading interrupt condition setting portion for setting whether processing for reading said document by said document reading portion is to be interrupted when said notification portion notifies the user of said prescribed information.

7. An image forming apparatus, comprising:
a document transportation portion for transporting a document in a prescribed direction;
a light exposure portion exposing said document to light;
a transparent member having a transparent portion allowing passage of the light reflected from said document;
a drive portion for moving said transparent member in a direction opposite to said prescribed direction when the document is read;
a document reading portion for reading the light reflected from said document;
an image forming portion forming an image on a prescribed target based on information read by said document reading portion;
a first portion setting portion setting a first transmission portion included in said transparent portion in said transparent member as a transmission area used for allowing passage of said reflected light when said document is read;
a speed setting portion for setting a moving speed of said transparent member based on said first transmission portion;
a moving speed determination portion for determining whether the set moving speed of the transparent member is equal to or smaller than a prescribed moving speed; and
a control portion stopping execution of document reading using said first transmission portion when said moving speed determination portion determines that the moving speed of said transparent member is equal to or smaller than said prescribed moving speed.

8. The image forming apparatus according to claim 7, further comprising a notification portion for notifying a user of prescribed information when said moving speed determination portion determines that the moving speed of said transparent member is equal to or smaller than said prescribed moving speed.

9. An image reading apparatus, comprising:
a document transportation portion for transporting a document in a prescribed direction;
a light exposure portion exposing said document to light;
a transparent member having a transparent portion allowing passage of the light reflected from said document;
a drive portion for moving said transparent member in a direction opposite to said prescribed direction when the document is read;
a document reading portion for reading the light reflected from said document;
a first portion setting portion setting a first transmission portion included in said transparent portion in said transparent member as a transmission area used for allowing passage of said reflected light when said document is read;
a speed setting portion for setting a moving speed of said transparent member based on said first transmission portion;
a moving speed determination portion for determining whether the set moving speed of the transparent member is equal to or smaller than a prescribed moving speed; and
a change portion for changing said transmission area from said first transmission portion to a second transmission portion that has been set in advance when said moving speed determination portion determines that the moving speed of said transparent member is equal to or smaller than said prescribed moving speed; wherein
said speed setting portion sets said moving speed of said transparent member to a moving speed based on said second transmission portion when said change portion changes said transmission area from said transmission portion to said second transmission portion.

10. The image reading apparatus according to claim 9, further comprising a foreign matter detection portion detecting whether a foreign matter is present on said transparent member, wherein
said first portion setting portion sets said first transmission portion based on a portion where a foreign matter having a size equal to or larger than a prescribed size is absent, out of the transparent portion of said transparent member.

11. The image reading apparatus according to claim 9, further comprising an instruction setting portion for setting a setting instruction as to whether said change portion permits change from said first transmission portion to said second transmission portion, wherein
said change portion changes the transmission area from said first transmission portion to said second transmission portion in accordance with said setting instruction.

12. The image reading apparatus according to claim 9, further comprising a notification portion for notifying a user of prescribed information when said moving speed determination portion determines that the moving speed of said transparent member is equal to or smaller than said prescribed moving speed.

13. The image reading apparatus according to claim 12, further comprising a foreign matter detection portion detecting whether a foreign matter is present on said transparent member, wherein
said prescribed information is information based on the foreign matter detected by said foreign matter detection portion.

14. The image reading apparatus according to claim 12, further comprising a reading interrupt condition setting portion for setting whether processing for reading said document by said document reading portion is to be interrupted when said notification portion notifies the user of said prescribed information.

15. A method of reading an image, comprising the steps of:
transporting a document in a prescribed direction;
exposing said document to light;
moving a transparent member having a transparent portion allowing passage of the light reflected from said document in a direction opposite to said prescribed direction when the document is read;
reading the light reflected from said document;
setting a first transmission portion included in said transparent portion in said transparent member as a transmission area used for allowing passage of said reflected light when said document is read;
setting a moving speed of said transparent member based on said first transmission portion;
determining whether the set moving speed of the transparent member is equal to or smaller than a prescribed moving speed;
changing said transmission area from said first transmission portion to a second transmission portion that has been set in advance when it is determined at said determining step that the moving speed of said transparent member is equal to or smaller than said prescribed moving speed; and
setting said moving speed of said transparent member to a moving speed based on said second transmission portion when said change portion changes said transmission portion to said second transmission portion.

16. The method of reading an image according to claim 15, further comprising the steps of
detecting whether a foreign matter is present on said transparent member, and
setting said first transmission portion based on a portion where a foreign matter having a size equal to or larger than a prescribed size is absent, out of the transparent portion of said transparent member.

17. The method of reading an image according to claim 15, further comprising the steps of
setting a setting instruction as to whether change from said first transmission portion to said second transmission portion is permitted, and
changing the transmission area from said first transmission portion to said second transmission portion in accordance with said setting instruction.

18. The method of reading an image according to claim 15, further comprising the step of notifying a user of prescribed information when it is determined at said determining step that the moving speed of said transparent member is equal to or smaller than said prescribed moving speed.

19. The method of reading an image according to claim 18, further comprising the step of detecting whether a foreign matter is present on said transparent member, wherein
said prescribed information is information based on the foreign matter detected by said foreign matter detection portion.

20. The method of reading an image according to claim 18, further comprising the step of setting whether processing for reading said document is to be interrupted when said prescribed information is notified.
